(19) United States
(12) Patent Application Publication
(10) Pub. No.: US 2026/0222732 A1
(43) Pub. Date: Jul. 30, 2026

(54) ELECTRO-MECHANICAL DEVICE COMPRISING AN ELECTRICALLY SPLIT ARRAY OF MOVING ELEMENTS, AND METHODS OF CONTROLLING THEREOF

(71) Applicant: AUDIO PIXELS LTD., Rehovot (IL)

(72) Inventors: Yuval COHEN, Cherrybrook, New South Wales (AU); Eric Andreas HABER, Kibbutz Kfar Menahem (IL); Rephael HALACHMY, Rehovot (IL); Daniel LEWIN, Ramat HaSharon (IL)

(21) Appl. No.: 19/143,666

(22) PCT Filed: Dec. 20, 2023
(86) PCT No.: PCT/IL2023/051286

§ 371 Date: Jun. 26, 2025

(30) Foreign Application Priority Data
Dec. 26, 2022 (IL) 299527

(51) Int. Cl. H04R 1/40; H04R 1/06; H04R 3/12; H04R 19/02

(52) U.S. Cl. CPC H04R 1/403; H04R 1/06; H04R 3/12; H04R 19/02; H04R 2201/003; H04R 2201/401; H04R 2201/403; H04R 2400/01

(57) ABSTRACT

There is provided an electro-mechanical device comprising a first array comprising a plurality of first actuator elements, and a second array comprising a plurality of second actuator elements, the first array and the second array being located on a same substrate, wherein each of the first actuator elements is not electrically connected to any one of the second actuator elements, wherein control of an application of a voltage to at least one of a moving element or an electrode of an actuator element enables controlling motion of the moving element, wherein the first actuator elements are arranged along N_{R1} rows and N_{C1} columns, wherein N_{R1}≥1 and N_{C1}≥1, wherein at least one of N_{R1} or N_{C1} is equal to or larger than 2, wherein the second actuators elements are arranged along N_{R2} rows and N_{C2} columns, wherein at least one of N_{R2} or N_{C2} is equal to or larger than 2.

### FIELD OF THE INVENTION

The present invention relates generally to controlling motion of movable components in microelectromechanical systems (MEMS). According to some embodiments, it relates to controlling sound pressure level (SPL) originated by a digital sound reconstruction (DSR) speaker.

### BACKGROUND

References considered to be relevant as background to the presently disclosed subject matter (acknowledgement of these references herein is not to be inferred as meaning that they are in any way relevant to the patentability of the presently disclosed subject matter) include U.S. Pat. Nos. 8,085,964, 8,457,338, 8,126,163, EP 2158787, U.S. Pat. Nos. 8,374,056, 8,755,556, 8,780,673, 9,391,541, 9,986,343, 10,503,136, 9,654,890, 9,880,533, 9,510,103, 8,994,126, 9,497,526, 9,445,170, 10,520,601, 10,554,166 and 10,433,067. All these references are of the Applicant, and their content is incorporated herein by reference in their entirety.

### GENERAL DESCRIPTION

In accordance with certain aspects of the presently disclosed subject matter, there is provided an electro-mechanical device comprising a first array comprising a plurality of first actuator elements, and a second array comprising a plurality of second actuator elements, wherein the first array and the second array are located on a same substrate, wherein each of the first actuator elements of the first array is not electrically connected to any one of the second actuator elements of the second array, wherein each of the first actuator elements and of the second actuator elements comprises a moving element, at least one electrode, and a bearing coupled to the moving element, wherein control of an application of a voltage to at least one of the moving element or the electrode enables controlling motion of the moving element, wherein the first actuator elements are arranged along N_{R1} rows and N_{C1} columns of the first array, wherein N_{R1}≥1 and N_{C1}≥1, wherein at least one of N_{R1} or N_{C1} is equal to or larger than 2, wherein the first array comprises a plurality of first electrical connections arranged such that (i) or (ii) is met: (i) for N_{C1}≥2, the moving elements of the first actuator elements belonging to a same row of the first array are electrically connected, and for N_{R1}≥2, the electrodes of the first actuator elements belonging to a same column of the first array are electrically connected, or (ii) for N_{R1}≥2, the moving elements of the first actuator elements belonging to a same column of the first array are electrically connected, and for N_{C1}≥2, the electrodes of the first actuator elements belonging to a same row of the first array are electrically connected, wherein the plurality of second actuators elements are arranged along N_{R2} rows and N_{C2} columns, wherein at least one of N_{R2} or N_{C2} is equal to or larger than 2, wherein the second array comprises a plurality of second electrical connections arranged such that (iii) or (iv) is met: (iii) for N_{C2}≥2, the moving elements of the second actuator elements belonging to a same row of the second array are electrically connected, and for N_{R2}≥2, the electrodes of the second actuator elements belonging to a same column of the second array are electrically connected, or (iv) for N_{R2}≥2, the moving elements of the second actuator elements belonging to a same column of the second array are electrically connected, and for N_{C2}≥2, the electrodes of the second actuator elements belonging to a same row of the second array are electrically connected.

In addition to the above features, the system according to this aspect of the presently disclosed subject matter can optionally comprise one or more of features (i) to (xxxix) below, in any technically possible combination or permutation:
i. the electro-mechanical device comprises at least one electrical insulator located between the first array and the second array;
ii. the electro-mechanical device comprises an electrical insulator which electrically insulates all electrodes of the first actuator elements from all electrodes of the second actuator elements;
iii. the electrical insulator is located in a layer used to manufacture the electrodes of the first actuator elements and the electrodes of the second actuator elements;
iv. the electro-mechanical device comprises an electrical insulator which electrically insulates all moving elements of the first actuator elements from all moving elements of the second actuator elements;
v. the electrical insulator is located in a layer used to manufacture the electrodes of the first actuator elements and the electrodes of the second actuator elements;
vi. the electrical insulator comprises an electrical insulator which electrically insulates all moving elements of the first actuator elements from all moving elements of the second actuator elements;
vii. the electrical insulator is located in a layer used to manufacture the moving elements of the first actuator elements and the moving elements of the second actuator elements;
viii. N_{R2} is equal to N_{R1};
ix. N_{C2} is equal to N_{C1};
x. a number of the first actuator elements is different from a number of the second actuator elements;
xi. N_{C2} is equal to N_{C1};
xii. the N_{R1} rows of the first array are parallel to the N_{R2} rows of the second array;
xiii. the number N_{R1} of rows of the first array is different from the number N_{R2} of rows of the second array;
xiv. the first array comprises a single row and at least two columns, wherein the second array comprises at least two rows and at least two columns;
xv. N_{R2} is equal to N_{R1};
xvi, the N_{C2} columns are parallel to the N_{C1} columns;
xvii, the number N_{C2} of columns of the second array is different from the number N_{C1} of columns of the first array;
xviii, the first array comprises a single column and at least two rows, wherein the second array comprises at least two rows and at least two columns;
xix. the electrical insulator extends along a direction parallel to the rows of the first array or of the second array;
xx. the electrical insulator extends along a direction parallel to the columns of the first array or of the second array;
xxi. the first array and the second array are located on a same die located on said same substrate;
xxii. the first array is located on a first die, and the second array is located on a second die distinct from the first die, wherein the first die and the second die are located on said same substrate;
xxiii. the electro-mechanical device is operative to generate a sound in a range of wavelengths including a minimal wavelength value Amin, wherein any of the first actuator elements of the first array is located at a distance from any of the second actuator elements of the second array which is equal to or smaller than λₘᵢₙ;
xxiv. the electro-mechanical device comprises a third array comprising a plurality of third actuator elements, wherein the first array, the second array and the third array are located on a same substrate, wherein each of the third actuator elements comprises a moving element, at least one electrode, and a bearing coupled to the moving element, wherein control of an application of a voltage to at least one of the moving element or the electrode enables controlling motion of the moving element, wherein each of the third actuator elements of the third array is not electrically connected to any one of the first actuator elements of the first array and to any one of the second actuator elements of the second array;
xxv. each first actuator element comprises a moving element operative to move along a first axis, and each second actuator element comprises a moving element operative to move along a second axis orthogonal to the first axis;
xxvi. the electro-mechanical device further comprises a controller operative to obtain a digital input signal sampled periodically in accordance with a sampling clock, wherein, for a given sampled value of the digital input signal at a given sampling time, the controller is operative to enable application of a voltage bias between an electrode and a moving element of a first number of first actuator elements of the first array, and to enable application of a voltage bias between an electrode and a moving element of a second number of second actuator elements of the second array, for generating a sound, wherein at least one attribute thereof corresponds to said given sampled value according to a matching criterion;
xxvii. each first actuator element comprises a moving element operative to move along a first axis, and each second actuator element comprises a moving element operative to move along a second axis orthogonal to the first axis;
xxviii. the electro-mechanical device further comprises a controller operative to obtain a digital input signal sampled periodically in accordance with a sampling clock, wherein, for a given sampled value of the digital input signal at a given sampling time, the controller is operative to enable application of a voltage bias between an electrode and a moving element of a first number of first actuator elements of the first array, and to enable application of a voltage bias between an electrode and a moving element of a second number of second actuator elements of the second array, for generating a sound, wherein at least one attribute thereof corresponds to said given sampled value according to a matching criterion;
xxix. the controller is operatively coupled to a database, storing, for each of a plurality of signal values, first data informative of a number of moving elements of the first actuator elements to be moved, and second data informative of a number of moving elements of the second actuator elements to be moved, wherein the controller is configured to: extract, from the database, given first data informative of a number of moving elements of the first actuator elements to be moved, and given second data informative of a number of moving elements of the second actuator elements to be moved, wherein the given first data and the given second data are associated in the database with a signal value matching the given sampled value according to a matching criterion, and control the first array and the second array using said given first data and given second data;
xxx. the controller is operative to use an optimization method to determine the first number of first actuator elements of the first array to be moved and the second number of second actuator elements of the second array to be moved;
xxxi. for any column of the first array in which a moving element is moved in response to a command of the controller, a motion of at least all operative moving elements of said column of the first array is also induced, or for any column of the second array in which a moving element is moved in response to a command of the controller, a motion of at least all operative moving elements of said column of the second array is also induced;
xxxii. for any row of the first array in which a moving element is moved in response to a command of the controller, a motion of at least all operative moving elements of said row of the first array is also induced, or for any row of the second array in which a moving element is moved in response to a command of the controller, a motion of all moving elements of said row of the second array is also induced;
xxxiii. all moving elements of the first array are electrically connected to a same electrical potential;
xxxiv. all moving elements of the second array are electrically connected to a same electrical potential;
xxxv. all electrodes of the first array are electrically connected to a same electrical potential;
xxxvi. all electrodes of the second array are electrically connected to a same electrical potential;
xxxvii. for any column of the first array in which a moving element is moved in response to a command of the controller, a motion of at least all operative moving elements of said column of the first array is also induced, and for any row of the second array in which a moving element is moved in response to a command of the controller, a motion of at least all operative moving elements of said row of the second array is also induced;
xxxviii. all moving elements of the first array are electrically connected to a same first electrical potential and all electrodes of the second array are electrically connected to a same second electrical potential; and
xxxix. the electro-mechanical device is part of a digital sound reconstruction speaker, or of a detection system.

In accordance with certain aspects of the presently disclosed subject matter, there is provided a digital sound reconstruction speaker comprising: a first array comprising a plurality of first actuator elements, a second array comprising a plurality of second actuator elements, and a controller, wherein the first array and the second array are located on a same substrate, wherein each of the first actuator elements of the first array is not electrically connected to any one of the second actuator elements of the second array, wherein each of the first actuator elements and of the second actuator elements comprises a moving element, at least one electrode, and a bearing coupled to the moving element, wherein control of an application of a voltage to at least one of the moving element or the electrode enables controlling motion of the moving element, wherein the first actuator elements are arranged along N_{R1} rows and N_{C1} columns of the first array, wherein N_{R1}≥1 and N_{C1}≥1, wherein at least one of N_{R1} or N_{C1} is equal to or larger than 2, wherein the first array comprises a plurality of first electrical connections arranged such that (i) or (ii) is met: (i) for N_{C1}≥2, the moving elements of the first actuator elements belonging to a same row of the first array are electrically connected, and for N_{R1}≥2, the electrodes of the first actuator elements belonging to a same column of the first array are electrically connected, or (ii) for N_{R1}≥2, the moving elements of the first actuator elements belonging to a same column of the first array are electrically connected, and for N_{C1}≥2, the electrodes of the first actuator elements belonging to a same row of the first array are electrically connected, wherein the second actuator elements are arranged along N_{R2} rows and N_{C2} columns, wherein at least one of N_{R2} or N_{C2} is equal to or larger than 2, wherein the second array comprises a plurality of second electrical connections arranged such that (iii) or (iv) is met: (iii) for N_{C2}≥2, the moving elements of the second actuator elements belonging to a same row of the second array are electrically connected, and for N_{R2}≥2, the electrodes of the second actuator elements belonging to a same column of the second array are electrically connected, or (iv) for N_{R2}≥2, the moving elements of the second actuator elements belonging to a same column of the second array are electrically connected, and for N_{C2}≥2, the electrodes of the second actuator elements belonging to a same row of the second array are electrically connected, wherein the controller is operative to obtain a digital input signal sampled periodically in accordance with a sampling clock, wherein, for a given sampled value of the digital input signal at a given sampling time, the controller is operative to enable application of a voltage bias between an electrode and a moving element of a first number of first actuator elements of the first array, and to enable application of a voltage bias between an electrode and a moving element of a second number of second actuator elements of the second array, for generating a sound, wherein at least one attribute thereof corresponds to said given sampled value according to a matching criterion.

In addition to the above features, the digital sound reconstruction speaker according to this aspect of the presently disclosed subject matter can optionally comprise one or more of features (i) to (xxxix) above, in any technically possible combination or permutation.

In accordance with certain aspects of the presently disclosed subject matter, there is provided a method of controlling an electro-mechanical device comprising a first array comprising a plurality of first actuator elements, and a second array comprising a plurality of second actuator elements, wherein the first array and the second array are located on a same substrate, wherein each of the first actuator elements of the first array is not electrically connected to any one of the second actuator elements of the second array, wherein each of the first actuator elements and of the second actuator elements comprises a moving element, at least one electrode, and a bearing coupled to the moving element, wherein control of an application of a voltage to at least one of the moving element or the electrode enables controlling motion of the moving element, the method comprising, by a controller: obtaining a digital input signal sampled periodically in accordance with a sampling clock, for a given sampled value of the digital input signal at a given sampling time, enabling application of a voltage bias between an electrode and a moving element of a first number of first actuator elements of the first array, and enabling application of a voltage bias between an electrode and a moving element of a second number of second actuator elements of the second array, for generating a sound, wherein at least one attribute thereof corresponds to said given sampled value according to a matching criterion.

According to some embodiments, the controller is operatively coupled to a database storing, for each a plurality of signal values, first data informative of a number of moving elements of the first actuator elements to be moved, and second data informative of a number of moving elements of the second actuator elements to be moved, wherein the method comprises extracting, from the database, given first data informative of a number of moving elements of the first actuator elements to be moved, and given second data informative of a number of moving elements of the second actuator elements to be moved, wherein the given first data and the given second data are associated in the database with a signal value matching the given sampled value according to a matching criterion, and controlling the first array and the second array using said given first data and given second data.

According to some embodiments, for any column of the first array in which a moving element is moved in response to a command of the controller, a motion of at least all operative moving elements of said column of the first array is also induced, or for any column of the second array in which a moving element is moved in response to a command of the controller, a motion of at least all operative moving elements of said column of the second array is also induced.

According to some embodiments, for any row of the first array in which a moving element is moved in response to a command of the controller, a motion of at least all operative moving elements of said row of the first array is also induced, or for any row of the second array in which a moving element is moved in response to a command of the controller, a motion of at least all operative moving elements of said row of the second array is also induced.

According to some embodiments, for any column of the first array in which a moving element is moved in response to a command of the controller, a motion of at least all operative moving elements of said column of the first array is also induced, and for any row of the second array in which a moving element is moved in response to a command of the controller, a motion of at least all operative moving elements of said row of the second array is also induced.

According to some embodiments, the method includes controlling an electro-mechanical device which comprises one or more of features (i) to (xxxix) above, in any technically possible combination or permutation.

In accordance with certain aspects of the presently disclosed subject matter, there is provided a method of manufacturing an electro-mechanical device, the method comprising creating an array of actuator elements arranged in rows and columns on a single die located on a substrate, wherein each actuator element includes a moving element, at least one electrode, and a bearing coupled to the moving element, creating an electrical insulator between a first subset of actuator elements and a second subset of actuator elements, to create a first array including said first subset of actuator elements and a second array including said second subset of actuator elements, wherein the electrical insulator electrically insulates all electrodes of the first subset of actuator elements from all electrodes of the second subset of actuator elements, or insulates all moving elements of the first subset of actuator elements from all moving elements of the second subset of actuators element, creating a plurality of first electrical connections, such that (i) or (ii) is met: (i) for a first array with more than one column, the moving elements of the first subset of actuators elements belonging to a same row of the first array are electrically connected, and, for a first array with more than one row, the electrodes of the first subset of actuator elements belonging to a same column of the first array are electrically connected, or (ii) for a first array with more than one row, the moving elements of the first subset of actuator elements belonging to a same column of the first array are electrically connected, and, for a first array with more than one column, the electrodes of the first subset of actuator elements belonging to a same row of the first array are electrically connected, generating a plurality of second electrical connections, such that (iii) or (iv) is met: (iii) for a second array with more than one column, the moving elements of the second subset of actuators elements belonging to a same row of the second array are electrically connected, and, for a second array with more than one row, the electrodes of the second subset of actuator elements belonging to a same column of the second array are electrically connected, or (iv) for a second array with more than one row, the moving elements of the second subset of actuators elements belonging to a same column of the second array are electrically connected, and, for a second array with more than one column, the electrodes of the second subset of actuators elements belonging to a same row of the second array are electrically connected.

According to some embodiments, the method includes manufacturing an electro-mechanical device which comprises one or more of features (i) to (xxxix) above, in any technically possible combination or permutation.

In accordance with certain aspects of the presently disclosed subject matter, there is provided a non-transitory computer readable medium comprising instructions that, when executed by one or more processing circuitries, cause the one or more processing circuitries to perform a method of controlling an electro-mechanical device comprising a first array comprising a plurality of first actuator elements, and a second array comprising a plurality of second actuator elements, wherein the first array and the second array are located on a same substrate, wherein each of the first actuator elements of the first array is not electrically connected to any one of the second actuator elements of the second array, wherein each of the first actuator elements and of the second actuator elements comprises a moving element, at least one electrode, and a bearing coupled to the moving element, wherein control of an application of a voltage to at least one of the moving element or the electrode enables controlling motion of the moving element, the method comprising obtaining a digital input signal sampled periodically in accordance with a sampling clock, for a given sampled value of the digital input signal at a given sampling time, enabling application of a voltage bias between an electrode and a moving element of a first number of first actuator elements of the first array, and enabling application of a voltage bias between an electrode and a moving element of a second number of second actuator elements of the second array, for generating a sound, wherein at least one attribute thereof corresponds to said given sampled value according to a matching criterion.

According to some embodiments, the method includes controlling an electro-mechanical device which comprises one or more of features (i) to (xxxix) above, in any technically possible combination or permutation.

According to some embodiments, the proposed solution enables generation of a physical effect (e.g. sound) which matches more accurately a desired input signal. In particular, the error between the physical effect and the input signal is reduced.

According to some embodiments, the proposed solution enables generation of a physical effect (e.g. sound) which contains less noise.

According to some embodiments, the proposed solution enables generation of a physical effect (e.g. sound) with better quality, in a large bandwidth of frequencies.

According to some embodiments, the proposed solution proposes an electro-mechanical device, including two arrays which can be manufactured using the same manufacturing process, thereby improving accuracy and quality of the manufacturing process.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 is a cross-sectional illustration of an individual actuator element in accordance with certain embodiments of the presently disclosed subject matter;

FIG. 2 is a cross-sectional illustration of another embodiment of an individual actuator element in accordance with certain embodiments of the presently disclosed subject matter;

FIG. 3A is a top view of an embodiment of an electro-mechanical device including a first array of actuator elements and a second array of actuator elements;

FIG. 3B is a side view of an embodiment of an electro-mechanical device including a first array of actuator elements and a second array of actuator elements manufactured on the same die located on a substrate;

FIG. 3C is a side view of an embodiment of an electro-mechanical device including an electrical insulator in the electrode layer, to insulate all electrodes of the first array of actuator elements from all electrodes of the second array of actuator elements;

FIG. 3D is a side view of an embodiment of an electro-mechanical device including an electrical insulator in the moving element layer, to insulate all moving elements of the first array of actuator elements from all moving elements of the second array of actuator elements;

FIG. 3E is a side view of an embodiment of an electro-mechanical device including a first array of actuator elements and a second array of actuator elements manufactured on different dies located on the same substrate;

FIG. 3F is a top view of another embodiment of an electro-mechanical device including a first array of actuator elements and a second array of actuator elements;

FIG. 3H is a top view of another embodiment of an electro-mechanical device including a first array of actuator elements and a second array of actuator elements;

FIG. 3I is a top view of another embodiment of an electro-mechanical device including a first array of actuator elements and a second array of actuator elements;

FIG. 3J is a top view of another embodiment of an electro-mechanical device including a first array of actuator elements, a second array of actuator elements, and a third array of actuator elements;

FIG. 3K is a top view of another embodiment of an electro-mechanical device including a first array of actuator elements, a second array of actuator elements, and a third array of actuator elements;

FIG. 3L is a top view of another embodiment of an electro-mechanical device including a first array of actuator elements, a second array of actuator elements a third array of actuator elements, and a fourth array of actuator elements;

FIG. 3M is a top view of another embodiment of an electro-mechanical device including a first array of actuator elements and a second array of actuator elements;

FIG. 3N is a top view of another embodiment of an electro-mechanical device including a first array of actuator elements and a second array of actuator elements;

FIG. 3O is a top view of another embodiment of an electro-mechanical device including a first array of actuator elements and a second array of actuator elements;

FIG. 3P is a top view of another embodiment of an electro-mechanical device including a first array of actuator elements and a second array of actuator elements;

FIG. 3Q is a top view of another embodiment of an electro-mechanical device including a first array of actuator elements and a second array of actuator elements;

FIG. 3R is a top view of another embodiment of an electro-mechanical device including a first array of actuator elements and a second array of actuator elements;

FIG. 3S is a top view of another embodiment of an electro-mechanical device including a first array of actuator elements and a second array of actuator elements;

FIG. 4A is a simplified functional block diagram of an apparatus (such as a digital sound reconstruction speaker) including an electro-mechanical device and a controller;

FIG. 4B is a generalized flow-chart of a method of controlling an electro-mechanical device including a first array and a second array;

FIG. 5A is a generalized flow-chart of an embodiment of a method of controlling an electro-mechanical device including a first array and a second array, using a database;

FIG. 5B is an example of the method of FIG. 5A;

FIG. 5C is an example of a database which can be used in the method of FIG. 5A;

FIGS. 5D and 5E illustrate examples of the control of a voltage bias between an electrode and a moving element in the first array (or in the second array) of the electro-mechanical device, in order to control motion of the moving elements;

FIG. 5F illustrates the addressing error in which a single array is used, in comparison to the example of FIG. 5A relying on two arrays;

FIG. 6A is a generalized flow-chart of an embodiment of a method of controlling an electro-mechanical device including a first array and a second array, using selection of full row(s) or full column(s) of the first array or of the second array;

FIG. 6B is an example of the method of FIG. 6A; and

FIG. 7 is a generalized flow-chart of an embodiment of a method of manufacturing an electro-mechanical device including a first array and a second array.

### DETAILED DESCRIPTION OF EMBODIMENTS

In the following detailed description, numerous specific details are set forth in order to provide a thorough understanding of the disclosure. However, it will be understood by those skilled in the art that the presently disclosed subject matter may be practiced without these specific details. In other instances, well-known methods, procedures, components and circuits have not been described in detail so as not to obscure the presently disclosed subject matter.

The term “bearing” as used herein is intended to include any device which allows constrained relative motion, such as bending motion, between parts e.g. a device which connects a moving element to stationary elements and defines the path of motion and the at-rest position of the moving element.

A “flexure bearing” or a “flexure” is a type of compliant mechanical bearing which allows motion by bending or twisting. A flexure bearing may comprise a flexible part joining two other parts and is typically simple, inexpensive, compact, and friction-free. Flexure bearings are typically formed of a material which can be repeatedly flexed without disintegrating.

A spring is intended to include any suitable elastic member such as but not limited to a spirally coiled strip or wire that recovers its shape after compression, bending, twisting, or stretching.

Addressing of an (i,j)'th actuator element in an array of actuator elements refers to application of voltage bias between a particular row (row i) and a particular column (column j) of the array of actuator elements.

ANSYS Inc.'s Glossary of MEMS Terminology states that a “dimple” is defined as follows: “a small feature or bump, typically a raised square on the surface of a MEMS device. Dimples can be used as mechanical stops e.g. to control the touch down in a high aspect ratio device”.

It is appreciated that the terms “top” and “bottom” are used in the description or the drawings merely for convenience to indicate locations on either side of a surface defined by the array of moving elements such as the surface connecting the midpoints of the trajectories of the moving elements. Gravity, in many applications, is a negligible force, such that a “top” location could equally well be disposed below or to the left or right of a “bottom” location.

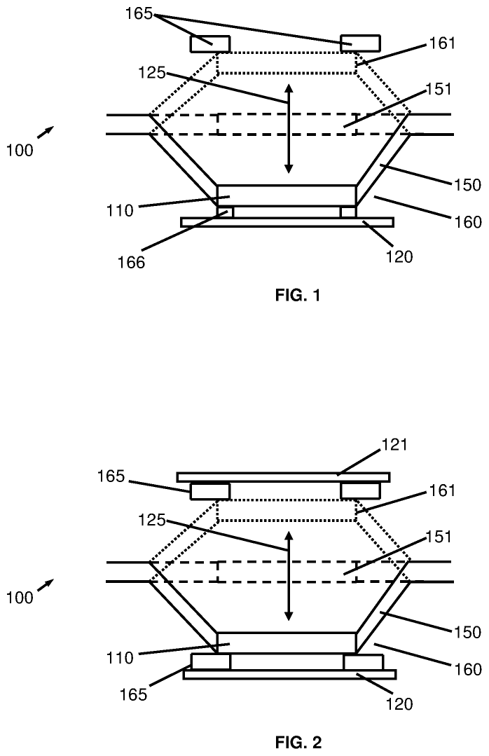

Attention is drawn to FIG. 1, which is a schematic representation of an actuator element 100 (also called “audio-pixel”) constructed and operative in accordance with certain embodiments of the present invention.

The actuator element 100 (also called “pixel” or “audio-pixel”) includes a moving element 110 (also called membrane, or electrical membrane, or moving membrane) and at least one electrode 120. A voltage can be applied (as explained hereinafter, this voltage can be controlled by a controller) to the moving element 110 and/or to the electrode 120. This generates a voltage bias between the moving element 110 and the electrode 120. The resulting electrostatic force enables a motion of the moving element 110. It is appreciated that the terms membrane and electrode are used in the description to refer to the moving and stationary elements respectively, however, in most practical applications both elements move when subjected to force, e.g. by applying a voltage between them. Typically, the membrane moves more than the electrode in response to said voltage but this need not be the case.

The moving element 110 is mechanically connected to stationary portions of the actuator element 100 by means of a bearing 150. The bearing 150 includes e.g. one or more flexures and/or one or more springs.

The bearing 150 defines an axis 125 along which the moving element 120 can travel (the axis 125 is e.g. orthogonal to the surface of the electrode 120). The bearing 150 defines an at-rest position 151 of the moving element 110.

When no voltage is applied to electrode 120 and to the moving element 110, the moving element 110 settles at the at-rest position 151.

In a first extreme position 160 (also called latched position), the moving element 110 is located in the vicinity of the electrode 120. In this first extreme position, the distance (along the axis 125) between the electrode 120 and the moving element 110 reaches a minimum (among all possible positions of the moving element 110). A latching voltage can be applied to the moving element 110 and/or to the electrode 120 to maintain the moving element 110 in this latched position.

In a second extreme position 161, the moving element 110 is located opposite to the electrode 120. In this second extreme position, the distance (along the axis 125) between the electrode 120 and the moving element 110 reaches a maximum (among all possible positions of the moving element 110).

In some embodiments, the actuator element 100 can include one or more mechanical stoppers. A mechanical stopper can be used to prevent the moving element 110 to further move away from the electrode 120. For example, the mechanical stopper (see reference 165 in FIG. 1) can define the second extreme position 161.

In some embodiments, the mechanical stopper prevents the moving element 110 from being in direct contact with the electrode 120.

In some embodiments, the mechanical stopper can include one or more dimples 166 formed on the surface of the electrode 120.

In the side view of FIG. 1, the electrode 120 is located below the moving element 110 (along the travel axis 125 of the moving element 110). Note that this is not mandatory, and the electrode 120 can be located above the moving element 110.

FIG. 2 describes a variant of the actuator element 100.

In this variant, the actuator element 100 includes a moving element 110 and two electrodes 120 and 121 disposed on opposite sides of the moving element 110. It is appreciated that the distances between the moving element 110 and each of the electrodes 120 and 121 may or may not be equal.

If no voltage is applied to electrodes 120 and 121 relative to the moving element 110, the moving element 110 settles at the at-rest position, in-between the top and bottom electrodes.

In a first extreme position 160, the moving element 110 is located in the vicinity of the bottom electrode 120. In this first extreme position 160, the distance (along the axis 125) between the electrode 120 and the moving element 110 reaches a minimum (among all possible positions of the moving element 110). In the example of FIG. 2, mechanical stoppers 165 define the first extreme position 160 and prevent the moving element 110 to be in contact with the bottom electrode 120.

In a second extreme position 161, the moving element 110 is located in the vicinity of the top electrode 121. In this second extreme position 161, the distance (along the axis 125) between the top electrode 121 and the moving element 110 reaches a minimum (among all possible positions of the moving element 110).

The moving elements and the electrode(s) are typically fabricated from an electrically conductive material, such as doped monocrystalline silicon, doped polycrystalline silicon, or aluminum, or at least contain an electrically conductive layer. Bearings are typically fabricated from a material capable of elastic deformation without or with minimal plastic deformation, such as monocrystalline silicon, polycrystalline silicon, or aluminum, such that bearings do not retain any permanent deformation in the absence of electrostatic forces, and moving elements always return to the exact same at-rest position when no electrostatic force is applied.

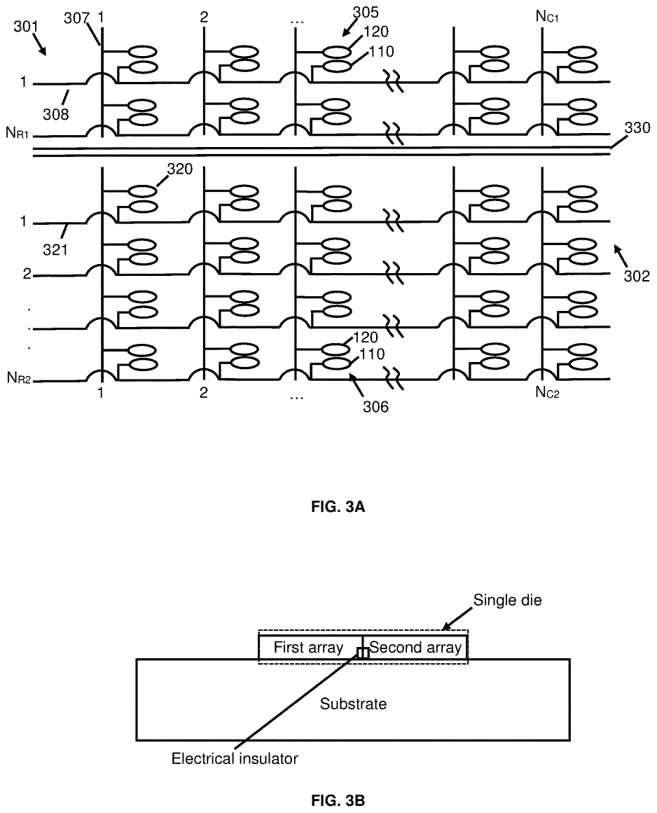

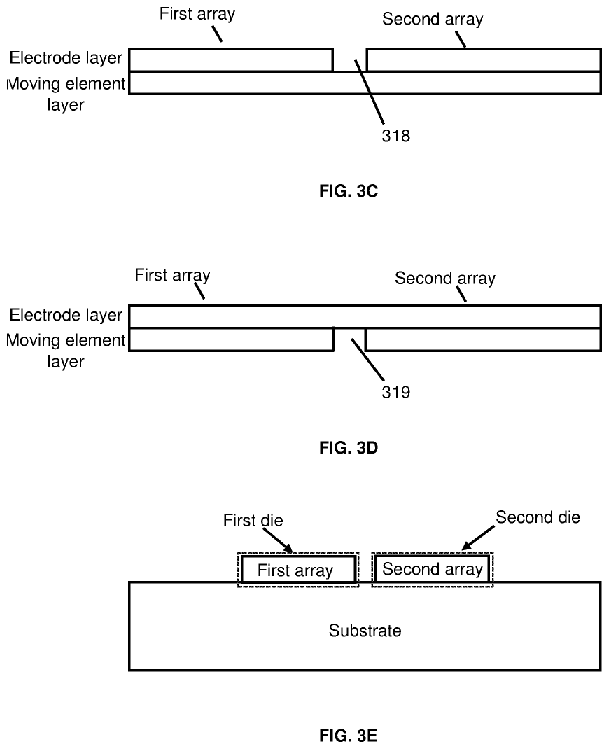

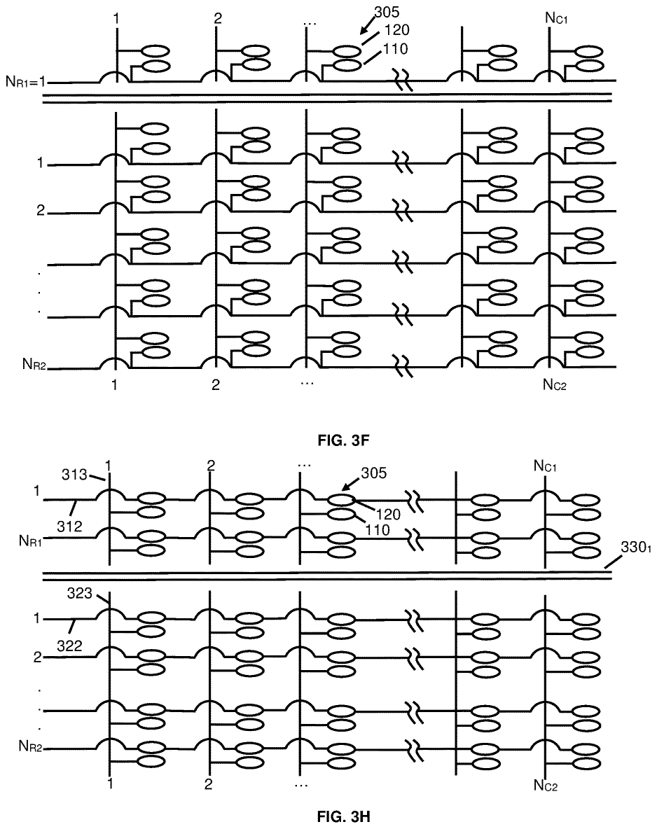

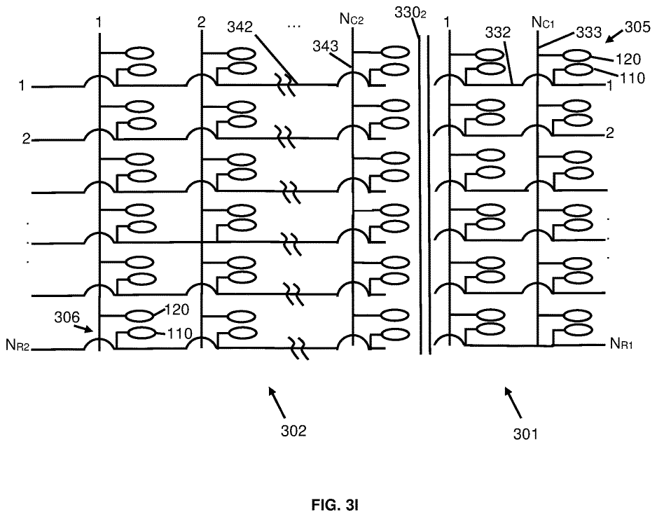

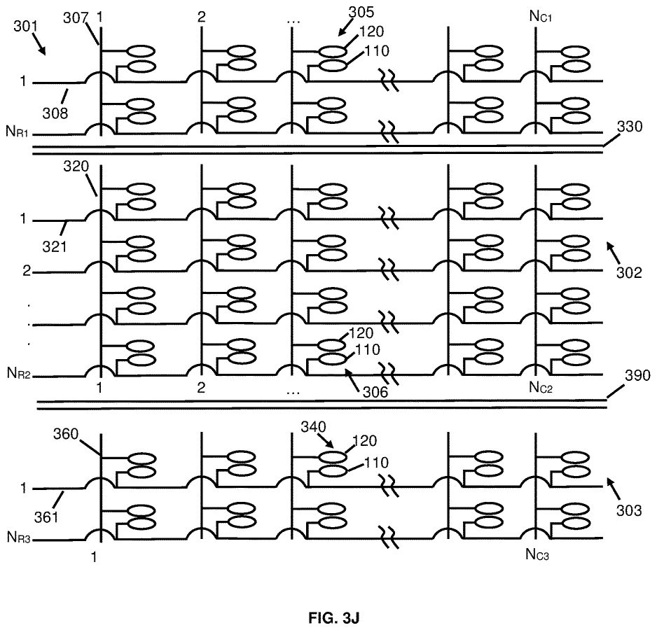

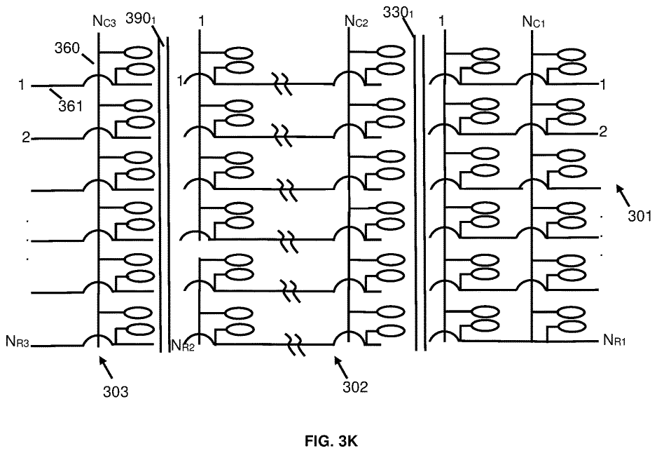

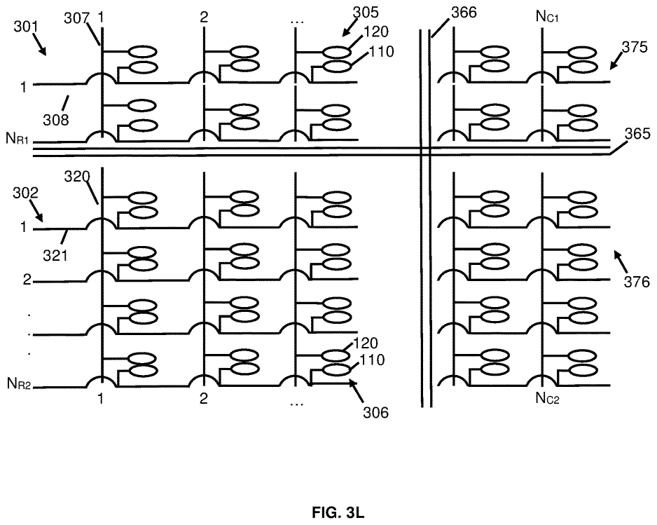

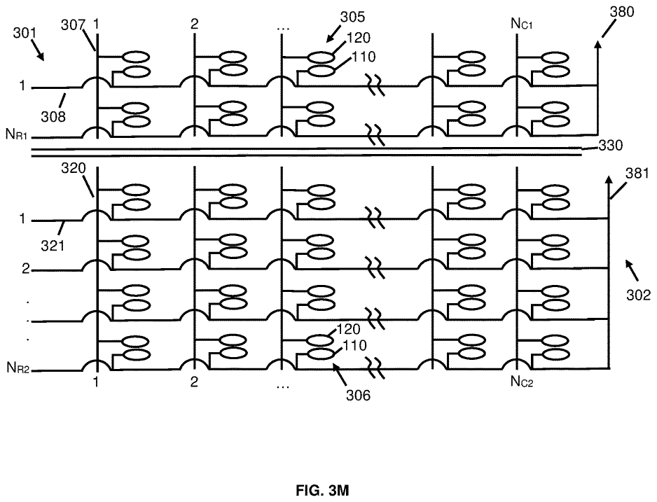

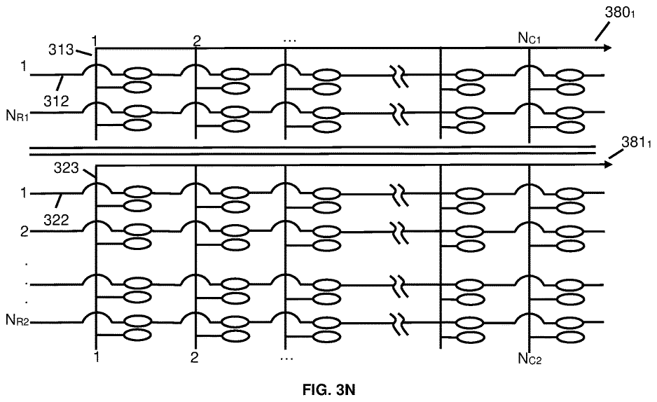

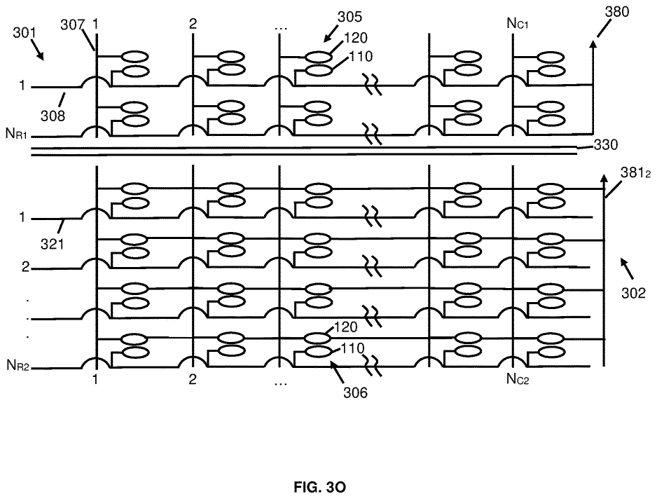

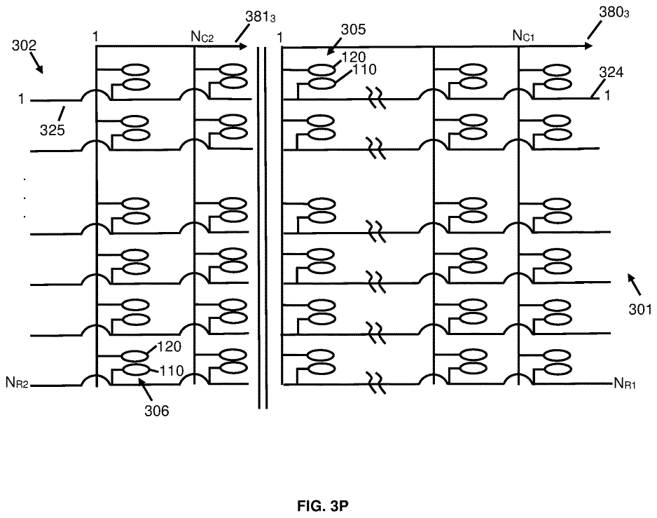

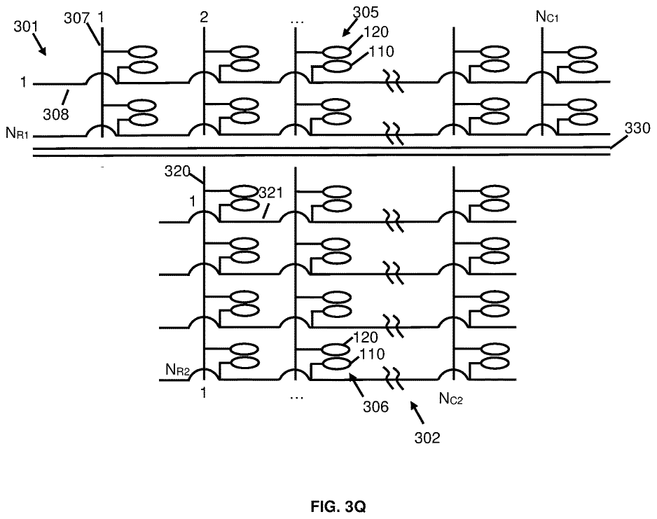

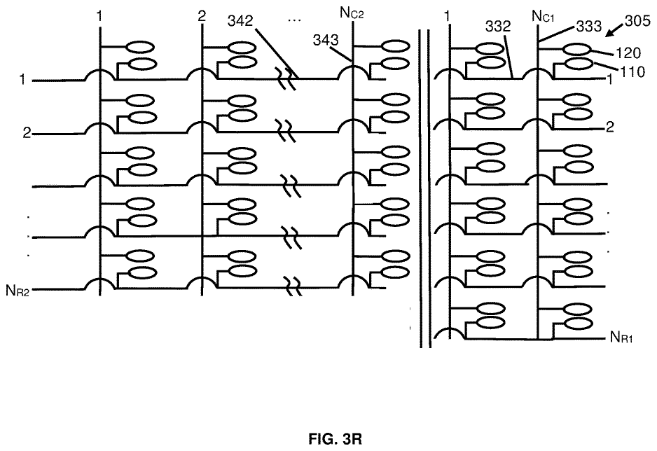

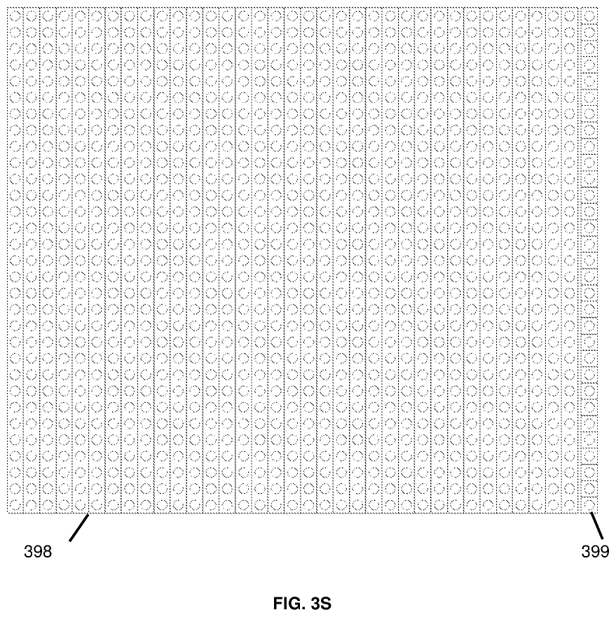

Attention is now drawn to FIG. 3A.

FIG. 3A depicts an embodiment of an electro-mechanical device 300. The electro-mechanical device 300 is a MEMS (Micro-Electrical Mechanical System) or a NEMS (Nano-Electronical Mechanical System).

As explained hereinafter, the electro-mechanical device 300 can be part of a digital sound reconstruction speaker. As explained hereinafter, the electro-mechanical device 300 can be controlled by a controller in order to generate a sound which complies with an input signal.

The electro-mechanical device 300 includes a first array 301 (also called first actuator array), and a second array 302 (also called second actuator array). The second array 302 is distinct from the first array 301. In some embodiments, the electro-mechanical device 300 can include more than two arrays.

The first array 301 includes a plurality of first actuator elements 305. Each of the first actuator elements 305 includes a moving element 110 and at least one electrode 120, as depicted with reference to FIG. 1.

Note that in some embodiments, each of the first actuator elements 305 can include a moving element 110 and two opposite electrodes 120, 121 as described with reference to FIG. 2.

The second array 302 includes a plurality of second actuator elements 306. Each of the second actuator elements 306 includes a moving element 110 and at least one electrode 120, as depicted with reference to FIG. 1.

Note that in some embodiments, each of the second actuator elements 306 can include a moving element 110 and two opposite electrodes 120, 121 as described with reference to FIG. 2.

In some embodiments, the first actuator elements 305 and the second actuator elements 306 have the same configuration: if each of the first actuator elements 305 includes a moving element 110 and a single electrode 120 (one-sided actuator element), then the same applies to each of the second actuator elements 306, and if each of the first actuator elements 305 includes a moving element 110 and two electrodes 120, 121 (two-sided actuator element), then the same applies to each of the second actuator elements 306. This is however not mandatory, and the first actuator elements can include one-sided actuator elements while the second actuator elements can include two-sided actuator elements, or conversely.

The first actuator elements 305 are arranged along N_{R1} rows and N_{C1} columns of the first array, with N_{R1}≥1, N_{C1}≥1. The number of rows and columns can be selected depending on various factors, such as the application, the required resolution, manufacturing costs, size of the device, etc.

In the non-limitative example of FIG. 3A, N_{R1} is equal to 2.

This is not limitative and N_{R1} can be smaller (see FIG. 3F in which N_{R1} is equal to 1) or can be larger than this value.

In some embodiments, the first array 301 includes more than one actuator element, and therefore, N_{R1}≥1, N_{C1}≥1, wherein N_{R1} and/or N_{C1} is equal to or larger than 2. This can apply also to the other embodiments described hereinafter.

The first array 301 includes first electrical connections 307, 308. The first electrical connections 307, 308 can include electrical wires.

In the embodiment of FIG. 3A, the first electrical connections 307, 308 are arranged such that all moving elements 110 of the first actuator elements 305 belonging to a same row of the first array 301 are electrically connected (see electrical connections 308), and all electrodes of the first actuator elements 305 belonging to a same column of the first array 301 are electrically connected (see electrical connections 307).

In the configuration of FIG. 3A, N_{C1} first electrical connections 307 and N_{R1} first electrical connections 308 are used.

As a consequence, when an electrical voltage is applied to a given electrical connection 308 (using a controller not represented in FIG. 3A), all the moving elements 110 electrically connected to this given electrical connection 308 receive this electrical voltage.

Similarly, when an electrical voltage is applied to a given electrical connection 307 (using a controller not represented in FIG. 3A), all the electrodes 120 electrically connected to this given electrical connection 307 receive this electrical voltage.

According to other embodiments (see a non-limitative example in FIG. 3H), the first electrical connections are arranged such that the moving elements 110 of all of the first actuator elements 305 belonging to a same column of the first array 301 are electrically connected (see first electrical connections 313) and the electrodes 120 of all of the first actuator elements 305 belonging to a same row of the first array 301 are electrically connected (see first electrical connections 312).

The second actuator elements 306 are arranged along N_{R2} rows and N_{C2} columns of the second array 302, with N_{R2}≥1 and N_{C2}≥1. The number of rows and columns can be selected depending on various factors, such as the application, the required resolution, manufacturing costs, size of the device, etc.

In a typical example, the second array 302 includes more than one actuator element, and therefore, N_{R2}≥1, N_{C2}≥1, wherein N_{R2} and/or N_{C2} is equal to, or larger than 2. This can apply also to the other embodiments described hereinafter.

According to some embodiments, the number N_{C2} of columns of the second array 302 is equal to the number N_{C1} of columns of the first array 301. An example of this configuration is illustrated in FIG. 3A. In this configuration, the number N_{R2} of rows of the second array 302 can be equal to the number N_{R1} of rows of the first array 301, or can differ from the number N_{R1} of rows of the first array 301. In some embodiments, the number N_{R2} of rows of the second array 302 is different from the number N_{R1} of rows of the first array 301 (asymmetric configuration).

The second array 302 includes second electrical connections 320, 321. The second electrical connections 320, 321 can include electrical wires.

In the embodiment of FIG. 3A, the second electrical connections 320, 321 are arranged such that the moving elements 110 of all of the second actuator elements 305 belonging to a same row of the second array 302, are electrically connected (see electrical connections 321), and the electrodes 120 of all of the second actuator elements 305 belonging to a same column of the second array 302, are electrically connected (see electrical connections 320).

In the configuration of FIG. 3A, N_{C2} second electrical connections 320 and N_{R2} second electrical connections 321 are used.

As a consequence, when an electrical voltage is applied to a given second electrical connection 321 (using a controller not represented in FIG. 3A), all the moving elements 110 electrically connected to this given second electrical connection 321 receive this electrical voltage.

Similarly, when an electrical voltage is applied to a given second electrical connection 320 (using a controller not represented in FIG. 3A), all the electrodes 120 electrically connected to this given second electrical connection 320 receive this electrical voltage.

Note that various features of the electro-mechanical device 300 described with reference to FIG. 3A can apply to the other variants of the electro-mechanical device described hereinafter, and therefore are not described again for each variant.

According to other embodiments (see a non-limitative example in FIG. 3H), the second electrical connections 322, 323 are arranged such that the moving elements 110 of all of the second actuator elements 306 belonging to a same column of the second array 301 are electrically connected (see second electrical connections 323), and the electrodes 120 of all of the second actuator elements 306 belonging to a same row of the second array are electrically connected (see second electrical connections 322).

FIG. 3F depicts a particular configuration in which the first array 301 includes a single row (N_{R1}=1), and a plurality of columns (N_{C1}≥2). The second array 302 includes a plurality of rows (N_{R2}≥2—therefore, N_{R2} is different from N_{R1}), and a plurality of columns (N_{C2}≥2). In this example, N_{C1} is equal to N_{C2}.

Note that a similar configuration can be used (not depicted), in which the first array 301 includes a single column (N_{C1}=1), and a plurality of rows (N_{R1}≥2). The second array 302 includes a plurality of columns (N_{C2}≥2—therefore, N_{C2} is different from N_{C1}) and a plurality of rows (N_{R2}≥2, with N_{R1} equal to N_{R2}).

Various embodiments of the first array 301 and of the second array 302 are described in the specification. In these embodiments, each of the first actuator elements of the first array 301 is not electrically connected to any one of the second actuator elements of the second array 302. In order to obtain this electrical independency between the two arrays, various methods can be used.

According to some embodiments, an electrical insulator can be used, which can extend along a direction which is (substantially) parallel to the rows of the first array 301 and of the second array 302 (see FIG. 3A), or which can extend along a direction which is (substantially) parallel to the columns of the first array 301 and of the second array 302 (see FIG. 3I).

According to some embodiments, the first array 301 and the second array 302 are manufactured on the same substrate (see FIGS. 3B to 3E).

The substrate can be e.g., a silicon wafer, a glass wafer, or a SOI (silicon on insulator) wafer. This is however not limitative.

According to some embodiments, the first array 301 and the second array 302 are manufactured using the same die (located on the same single die—see FIG. 3B). This common die is used to manufacture both the first actuator elements and the second actuator elements. For example, a first layer can be deposited on this die to manufacture the moving elements of the first and second arrays, and a second layer can be deposited on this die to manufacture the electrodes of the first and second arrays. In other words, the first array and the second array are manufactured simultaneously, in the same manufacturing process.

In some embodiments, in order to avoid an electrical connection between the first actuator elements and the second actuator elements, an electrical insulator can be used. This electrical insulator can be located at the interface between the first array 301 and the second array 302.

In some embodiments, the electrical insulator electrically insulates all electrodes of the first actuator elements from all electrodes of the second actuator elements. This electrical insulator can be located in a layer used to manufacture the electrodes of the first actuator elements and the electrodes of the second actuator elements. For example, the electrical insulator includes a trench 318 (see FIG. 3C), which is generated in the layer (electrode layer) used to manufacture the electrodes of the first actuator elements and the electrodes of the second actuator elements. This trench is therefore located in the electrode layer, at the interface between the first array and the second array. Note that the use of a trench is not limitative, and other electrical insulators can be used, such as section of undoped silicon between the doped silicon forming the electrode layers of each array It is appreciated that trench 318 can be left empty or filled with an insulating material such as silicon dioxide or silicon nitride (this is not limitative). If the trench is left unfilled, it may be open to the atmosphere or sealed under a vacuum.

Use of an electrical insulator to insulate the electrodes of the first array from the electrodes of the second array is particularly beneficial in a configuration in which each of the first electrical connections interconnecting the electrodes of the first actuator elements is aligned (along the same axis) with a corresponding second electrical connection interconnecting the electrodes of the second actuator elements (e.g. along the same row or along the same column). This is the case in FIG. 3A, in which, for each given column, the first electrical connection 307 interconnecting the electrodes 120 of the first actuator elements 305 along this given column and the second electrical connection 320 interconnecting the electrodes of the second actuator elements along this given column are (substantially) aligned. Therefore, an electrical insulator 330 can be created in the electrode layer (in the direction of the rows), to prevent an electrical connection between the first electrical connections 307 and the second electrical connections 320.

In the example of FIG. 3A, the first electrical connections 308 interconnecting the moving elements 110 of the first actuator elements 305 and the second electrical connections 321 interconnecting the moving elements 110 of the second actuator elements 306 extend along parallel directions (along the rows respectively of the first array and of the second array), and are not interconnected.

Therefore, in the example of FIG. 3A, the moving elements 110 of the first actuator elements 305 are, de facto, electrically insulated from the moving elements 110 of the second actuator elements 306. Note that it is possible to use an additional electrical insulator in the layer used to manufacture the moving elements of the first array and of the second array, to further insulate the moving elements of the first actuator elements from the moving elements of the second actuator elements, but this is not mandatory. This additional electrical insulator can also include e.g. a trench in the layer used to manufacture the moving elements of the two arrays (in the example of FIG. 3A, this trench would extend in a direction parallel to the rows of the arrays, at the interface between the first array and the second array).

In some embodiments, the electrical insulator electrically insulates all moving elements of the first actuator elements from all moving elements of the second actuator elements. This electrical insulator can be located in a layer used to manufacture the moving elements of the first actuator elements and the moving elements of the second actuator elements. For example, the electrical insulator includes a trench 319 (see FIG. 3D), which is generated in the layer (moving element layer) used to manufacture the moving elements of the first actuator elements and the moving elements of the second actuator elements. This trench is therefore located in the moving element layer, at the interface between the first array and the second array. Note that the use of a trench is not limitative, and other electrical insulators can be used, such as a layer of undoped silicon.

Use of an electrical insulator to insulate the moving elements of the first array from the moving elements of the second array is particularly beneficial in a configuration in which each of the first electrical connections interconnecting the moving elements of the first actuator elements is aligned (along the same axis) with a corresponding second electrical connection interconnecting the moving elements of the second actuator elements (e.g. along the same row or along the same column). This is the case in FIG. 3H, in which, for each given column, the first electrical connection 313 interconnecting the moving elements 110 of the first actuator elements along this given column, and the second electrical connection 323 interconnecting the moving elements 110 of the second actuator elements along this given column, are (substantially) aligned. Therefore, an electrical insulator 330₁ can be created in the moving element layer (in the direction of the rows), to prevent an electrical connection between the first electrical connections 313 and the second electrical connections 323.

In the example of FIG. 3H, the first electrical connections 313 interconnecting the electrodes of the first actuator elements and the second electrical connections 321 interconnecting the electrodes of the second actuator elements, extend along parallel directions (along the rows respectively of the first array and of the second array), and are not interconnected.

Therefore, in the example of FIG. 3H, the electrodes of the first actuator elements are, de facto, electrically insulated from the electrodes of the second actuator elements. Note that it is possible to use an additional electrical insulator in the layer used to manufacture the electrodes of the first array and of the second array, to further insulate the electrodes of the first actuator elements from the electrodes of the second actuator elements, but this is not mandatory. This additional electrical insulator can also include e.g. a trench in the layer used to manufacture the electrodes of the two arrays (in the example of FIG. 3H, this trench would extend in a direction parallel to the rows of the arrays, at the interface between the first array and the second array).

According to other embodiments, the first array 301 and the second array 302 are assembled on the same substrate, but are manufactured using different dies (see FIG. 3E). The first array is manufactured on a first die, and the second array is manufactured on a second die, distinct from the first die. The layers used to manufacture the first actuator elements are therefore different from the layers used to manufacture the second actuator elements.

In this configuration, since two distinct dies are used (and these dies are not electrically connected), the first actuator elements are, de facto, electrically insulated from the second actuator elements. If necessary, it is possible to add an electrical insulator between the two dies, in order to further prevent any electrical bridge between the two arrays.

Attention is drawn to FIG. 3I.

According to some embodiments. the electrical insulator 330₂ extends along a direction which is (substantially) parallel to the columns of the first array 301 and of the second array 302.

In this configuration, the number N_{R2} of rows of the second array 302 is generally equal to the number N_{R1} of rows of the first array 301.

In this configuration, the number N_{C2} of columns of the second array 302 can be equal to the number N_{C1} of columns of the first array 301, or can differ from the number N_{C1} of columns of the first array 301. In some embodiments, the number N_{C2} of columns of the second array 302 is larger than the number N_{C1} of columns of the first array 301 (asymmetric configuration).

In the example of FIG. 3I, the first electrical connections 332, 333 are arranged such that the moving elements 110 of all of the first actuator elements 305 belonging to a same row of the first array 301 are electrically connected (see first electrical connections 332), and the electrodes 120 of all of the first actuator elements 305 belonging to a same column of the first array 301 are electrically connected (see first electrical connections 333).

Note that in the configuration of FIG. 3I (in which the number N_{R2} of rows of the second array 302 is equal to the number N_{R1} of rows of the first array 301), it is possible to connect the first actuator elements 305 in a different way (not represented): the moving elements 110 of the first actuator elements 305 belonging to a same column of the first array 301 are electrically connected, and the electrodes 120 of the first actuator elements 305 belonging to a same row of the first array 301 are electrically connected.

In the example of FIG. 3I, the second electrical connections 342, 343 are arranged such that the moving elements 110 of all of the second actuator elements 306 belonging to a same row of the second array 302 are electrically connected (see second electrical connections 342), and the electrodes 120 of all of the first actuator elements 305 belonging to a same column of the second array 302 are electrically connected (see second electrical connections 343).

Note that in the configuration of FIG. 3I (in which the number N_{R2} of rows of the second array 302 is equal to the number N_{R1} of rows of the first array 301), it is possible to connect the second actuator elements 306 in a different way (not represented): the moving elements 110 of all of the second actuator elements 306 belonging to a same column of the second array 302 are electrically connected and the electrodes 120 of all of the second actuator elements 306 belonging to a same row of the second array 302 are electrically connected.

According to some embodiments (see e.g. FIGS. 3A, 3F and 3H), the N_{C2} columns of the second array 302 are aligned with the N_{C1} columns of the first array 301. In this case, for a given column Cᵢ of the first array 301, all first actuator elements 305 of this column Cᵢ are aligned with the first actuator elements 305 of the same column Cᵢ of the second array 302 along the same axis. In a top view of the electro-mechanical device 300, this axis can go through the center of the first actuator elements 305 and of the second actuator elements 306 belonging to the same column. In this configuration, the N_{R1} rows of the first array 301 are substantially parallel to the N_{R2} rows of the second array 302. Note that this is not limitative.

According to other embodiments (see e.g., FIG. 3I), the N_{R2} rows of the second array 302 are aligned with the N_{R1} rows of the first array 301. In this case, for a given row Rᵢ of the first array 301, all first actuator elements 305 of this row Rᵢ are aligned with the second actuator elements 306 of the same row Rᵢ of the second array 302 along the same axis. In a top view of the electro-mechanical device 300, this axis can go through the center of the first actuator elements 305 and of the second actuator elements 306 belonging to the same row. In this configuration, the N_{C1} columns of the first array 301 are substantially parallel to the N_{R2} columns of the second array 302. Note that this is not limitative. Indeed, the column or row alignment is not a physical and/or acoustic requirement but is generally selected for minimizing cost.

FIG. 3J illustrates another configuration in which the electro-mechanical device 300 includes a first array 301, a second array 302, and a third array 303. The third array 303 includes a plurality of third actuator elements 340. Each of the first actuator elements 340 includes a moving element 110 and at least one electrode 120, as depicted with reference to FIG. 1, or a moving element 110 and two opposite electrodes 120, 121, as described with reference to FIG. 2.

As visible in FIG. 3J, the third actuator elements 340 are arranged along N_{R3} rows and N_{C3} columns of the second array 302, with N_{R3}≥1 and N_{C3}≥1. In some embodiments, N_{R3} and/or N_{C3} is equal to or greater than 2.

The third array 303 can include third electrical connections (see 360, 361 in FIG. 3J, and 360₁, 361₁ in FIG. 3K), which can connect respectively the moving elements along the rows (or the columns) of the third array 303 and the electrodes along the row (or the columns) of the third array 303.

The electrical connections of the third array 303 can be arranged according to any of the arrangements described above for the first array 301 and/or the second array 302.

In the example of FIG. 3J, N_{C3} is equal to N_{C2} and to N_{C1} (however, in this configuration, N_{R3} may differ from N_{R2} and N_{R1}, although this is not mandatory).

In this configuration, a first electrical insulator 330 between the first array 301 and the second array 302 extends along a direction substantially parallel to the rows of the first array 301 and to the rows of the second array 302. The first electrical insulator 330 insulates e.g. the electrodes of the first array from the electrodes of the second array (and also from the electrodes of the third array).

Similarly, a second electrical insulator 390 between the second array 302 and the third array 303 extends along a direction substantially parallel to the rows of the second array 302 and to the rows of the third array 303. The second electrical insulator 390 insulates e.g. the electrodes of the second array from the electrodes of the third array.

FIG. 3K describes a variant of the configuration of FIG. 3J.

In FIG. 3K, N_{R3} is equal to N_{R2} and to N_{R1} (however, in this configuration, N_{C3} may differ from N_{C2} and N_{C1}, although this is not mandatory).

In the configuration of FIG. 3K, the first electrical insulator 330₁ between the first array 301 and the second array 302 extends along a direction substantially parallel to the columns of the first array 301 and to the rows of the second array 302. The first electrical insulator 330₁ insulates e.g. the moving elements of the first array from the elements of the second array (and also from the moving elements of the third array).

Similarly, the second electrical insulator 390₁ between the second array 302 and the third array 303 extends along a direction substantially parallel to the columns of the second array 302 and to the rows of the third array 303. The second electrical insulator 390₁ insulates e.g. the moving elements of the second array from the moving elements of the third array.

Attention is now drawn to FIG. 3L.

According to some embodiments, it is possible to create two electrical insulators 365, 366 which extend along two different directions (e.g. one along the direction of the rows of the various arrays, and one along the direction of the columns of the various arrays), thereby enabling creation of at least four arrays 301, 302, 375, 376. Each array of the four arrays is electrically isolated from the three other arrays. Each array can be arranged according to the various embodiments described above.

In the example of FIG. 3L, the electrical insulator 365 insulates e.g. the electrodes of the array 301 and of the array 375 from the electrodes of the array 302 and of the array 376.

The electrical insulator 366 insulates e.g. the moving elements of the array 301 and of the array 302 from the moving elements of the array 375 and of the array 376.

The moving elements of the arrays 301, 302, 375 and 376 are connected along a direction parallel to the rows of their respective array. Since the rows of the array 301 are not aligned with the rows of the arrays 302 and 376, the moving elements of the array 301 are de facto insulated from the moving elements of the arrays 302 and 376.

The electrodes of the arrays 301, 302, 375 and 376 are connected along a direction parallel to the columns of their respective array. Since the columns of the array 301 are not aligned with the columns of the arrays 302 and 376, the electrodes of the array 301 are de facto insulated from the electrodes of the arrays 302 and 376.

Attention is now drawn to FIG. 3M, which is a variant of the configuration of FIG. 3A.

In this configuration, all moving elements 110 (which are connected along the rows) of the first array 301 are all electrically connected to the same first electric potential 380.

In addition, all moving elements 110 (which are connected along the rows) of the second array 302 are all electrically connected to the same second electric potential 381 (which can be different from the first electrical potential 380).

As explained hereinafter, this enables, for each given array, to always select the whole column of each given array.

Attention is now drawn to FIG. 3N, which is a variant of the configuration of FIG. 3H.

In this configuration, all moving elements 110 (which are connected along the columns) of the first array 301 are all electrically connected to the same first electric potential 380₁.

In addition, all moving elements 110 (which are connected along the columns) of the second array 302 are all electrically connected to the same second electric potential 381₁ (which can be different from the first electrical potential 380₁).

As explained hereinafter, this enables, for each given array, to always select the whole row of each given array.

Attention is now drawn to FIG. 3O, which is a variant of the configuration of FIG. 3M. In this embodiment, the first array 301 is separated from the second array 302 by an electrical insulator which extends along a direction which is (substantially) parallel to the rows of the first array 301 and of the second array 302. Assume that the second array 302 has a number of rows which is larger than the number of rows of the first array 301. The second array 302 of FIG. 3O is such that all electrodes 120 of the second array 302 are all electrically connected to the same first electric potential 381₂. The moving elements 110 of all of the second actuator elements 306 belonging to a same row of the second array 302 are electrically connected (see electrical connections 321).

The first array 301 of FIG. 3O is identical to the first array 301 of FIG. 3M.

Attention is now drawn to FIG. 3P, which depicts a first array 301 and a second array 302 separated by an electrical insulator which extends along a direction which is (substantially) parallel to the columns of the first array 301 and of the second array 302.

In this configuration, all electrodes 120 of the first array 301 are all electrically connected to the same first electric potential 380₃. Similarly, all electrodes 120 of the second array 302 are all electrically connected to the same first electric potential 381₃.

In the embodiment of FIG. 3P, the first electrical connections 324 are arranged such that all moving elements 110 of the first actuator elements 305 belonging to a same row of the first array 301 are electrically connected (see electrical connections 324). Similarly, the first electrical connections 325 are arranged such that all moving elements 110 of the second actuator elements 306 belonging to a same row of the second array 302 are electrically connected (see electrical connections 325).

Attention is now drawn to FIG. 3P.

Assume that an electrical insulator extends parallel to the rows of the first array 301 and of the second array 302.

In such a configuration, in the embodiments of FIGS. 3A, 3F and 3H, the number N_{C1} of columns of the first actuator elements 305 of the first array 301 is equal to the number N_{C2} of columns of the second actuator elements 306 of the first array 302.

FIG. 3Q depicts a variant, in which the number N_{C1} of columns of the first actuator elements 305 of the first array 301 is different from the number N_{C2} of columns of the second actuator elements 306 of the second array 302. In this example, N_{C2}<N_{C1}. Note that in other embodiments (not depicted), N_{C2}>N_{C1}.

In this configuration, at least part of the columns of the second array 302 are aligned with at least part of the columns of first array 301.

Attention is now drawn to FIG. 3R.

Assume that an electrical insulator extends parallel to the columns of the first array 301 and of the second array 302.

In such a configuration, in the embodiments of FIG. 3I, the number N_{R1} of rows of the first actuator elements 305 of the first array 301 is equal to the number N_{R2} of rows of the second actuator elements 306 of the second array 302.

FIG. 3R depicts a variant in which the number N_{R1} of rows of the first actuator elements 305 of the first array 301 is different from the number N_{R2} of rows of the second actuator elements 306 of the first array 302. In this example, N_{R2}<N_{R1}. Note that in other embodiments (not depicted), N_{R2}>N_{R1}.

In this configuration, at least part of the rows of the second array 302 are aligned with at least part of the rows of first array 301.

As mentioned in the various embodiments, the first array and the second array can be located on the same substrate (in some embodiments, they can be located on the same die which is located on the same substrate).

Since the first array and the second array are located on the same substrate, it is possible to reduce the distance between the first array and the second array. Assume that the electro-mechanical device 300 is used to generate a sound, which is located in a range of wavelengths including a minimal wavelength value 2 min. This minimal wavelength depends on the application. For example, it could belong to the audible sound range, or to the ultrasound range. This is not limitative.

The distance between the first array and the second array (this distance can be measured e.g. in a plane which is parallel to the surface of the substrate) can be selected with respect to λₘᵢₙ.

In particular, in some embodiments, any of the first actuator elements of the first array is located at a distance from any of the second actuator elements of the second array which is equal to or smaller than λₘᵢₙ. This enables obtaining an omnidirectional device (omnidirectional sound system).

In some embodiments, if the distance between the first array and the second array is larger than λₘᵢₙ, it is possible to take into account the position of the listener: if the distance between the position of the listener and the first array is different from the distance between the position of the listener and the second array, it is possible to add a delay to the signals of the array which is the closest to the position of the listener (such that the signal produced by the first array and the signal produced by the second array arrive at the listener simultaneously). This delay compensates the time-of-flight difference between the two arrays.

If these two distances are similar/equal, it is not necessary to add this delay, since the signal produced by the first array and the signal produced by the second array arrive at the listener simultaneously.

Attention is now drawn to FIG. 3S.

According to some embodiments, the first array is placed horizontally and the second array is placed vertically (or conversely). In particular, each first actuator element (of the first array) comprises a moving element operative to move along a first axis, and each second actuator element (of the second array) comprises a moving element operative to move along a second axis orthogonal to the first axis. An example is illustrated in FIG. 3S, in which one of the arrays 398 has columns of actuator elements which extend vertically (this means that for each actuator element, its moving element moves along a vertical axis), whereas the other array 399 has columns of actuator elements which extend horizontally (this means that for each actuator element, its moving element moves along a horizontal axis). Note that in this example, each column of the other array 399 includes only one actuator element—this is however not limitative.

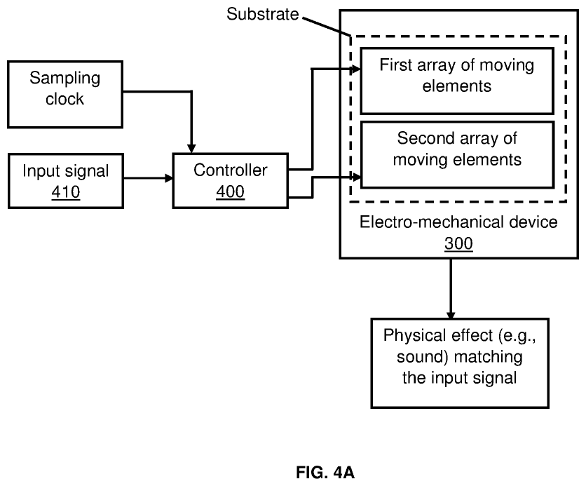

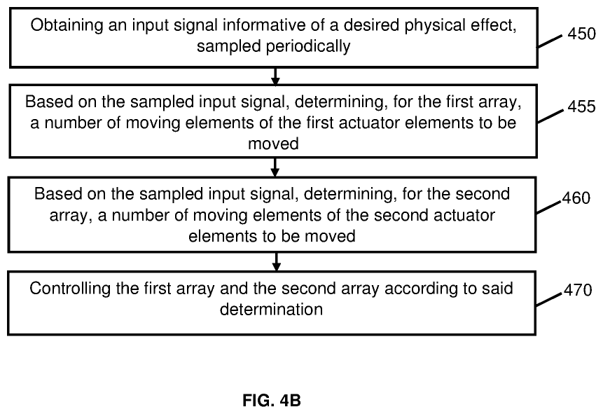

Attention is now drawn to FIGS. 4A and 4B.

In order to control the electro-mechanical device 300 (according to one of the embodiments above), at least one controller 400 can be used, operatively coupled to the first array 301 and to the second array 302 of the electro-mechanical device 300 (or to the plurality of arrays if more than two arrays are used).

The controller 400 can be part of the electro-mechanical device 300 or can be external to it. Note that, in a typical example, the number of first actuator elements is different from the number of second actuator elements.

The controller 400 can receive an input signal 410 (operation 450). The controller 400 may incorporate an industry standard interface to receive the digital input signal, such as but not limited to an I2S, AC'97, HDA, or SLIMbus interface.

The input signal 410 can be sampled periodically, according to a sampling clock (a sampler, not represented, can be used to sample the input signal 410). The input signal 410 is informative of the desired physical effect which has to be produced by the electro-mechanical device 300.

In some embodiments, the input signal 410 is informative of a desired sound to be produced by the electro-mechanical device 300. In this case, the electro-mechanical device 300 is part of a digital sound reconstruction system (DSR). Note that the electro-mechanical device 300 can be used in different systems. For example, in some embodiments, it can be used in a detection system. For example, the detection system may enable sonar applications (for example, for mapping the surrounding space or gesture input).

In some embodiments, the amplitude of the input signal 410 can correspond to the desired sound intensity (sound pressure level). In some embodiments, the frequency of the input signal 410 can correspond to the pitch of the desired sound. The controller 400 can control the position of each moving element in each of the first array and the second array (as mentioned above, more than two arrays can be used), as a function of the digital input signal sampled in accordance with a sampling clock.

The controller 400 can use the sampled input signal 410 to determine the number of moving elements of the first actuator elements that need to be moved, and/or the number of moving elements of the second actuator elements that need to be moved (operations 455 and 460). The first array and the second array are then controlled accordingly (operation 470).

Control of the motion of the moving elements of the first and/or the second actuator elements can include e.g. moving a moving element from its at-rest position to an extreme position at which it is latched in close proximity to the electrode. This can include releasing a moving element from its extreme position (latched position) in order to let the moving element reach its at-rest position.

For example, the controller 400 may latch or release individual moving elements, such that the number of latched moving elements always equals the number represented by the last (most recently received) data word of the digital input signal received by the controller 400.

Alternatively, the algorithm used by the controller 400 may be such that the number of unlatched moving elements equals the last data word received.

In some embodiments, the controller 400 generates one or more voltages which are transmitted to a high voltage driver (not represented), which converts low voltages generated by the controller 400 into higher voltages adapted to drive the actuator elements of the first array and of the second array.

The high voltage driver may, for example, have an amplifier or voltage level shifting functionality allowing relatively high voltages, such as some tens of volts, to be applied between the electrode and the moving element 110 under the control of low-voltage signals transmitted from the controller 400.

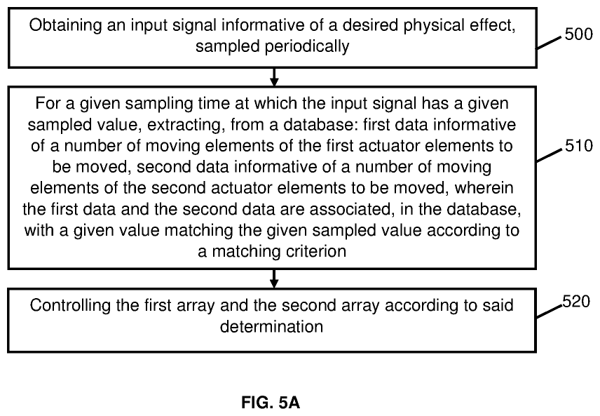

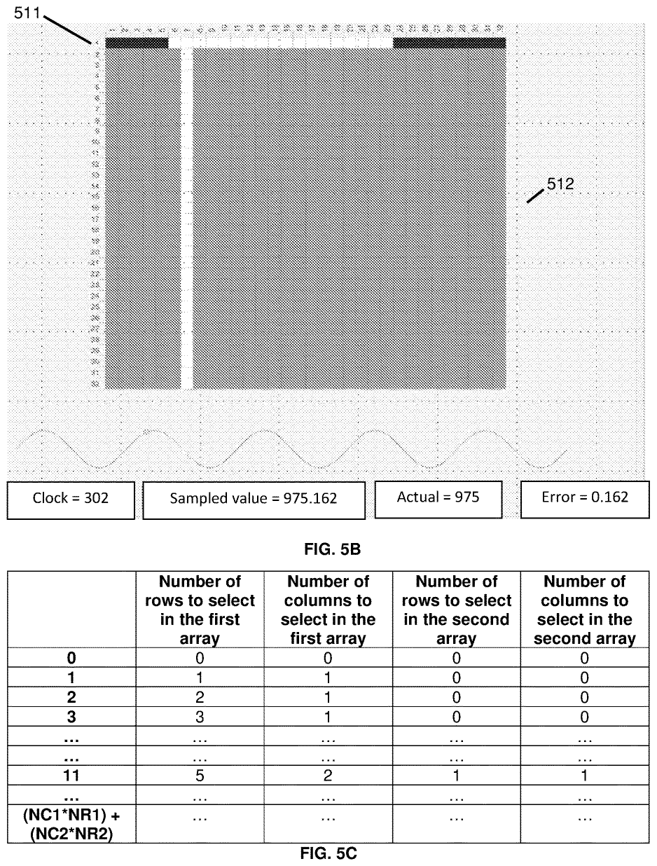

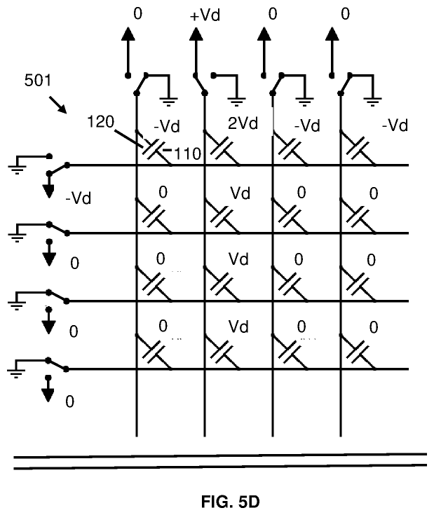

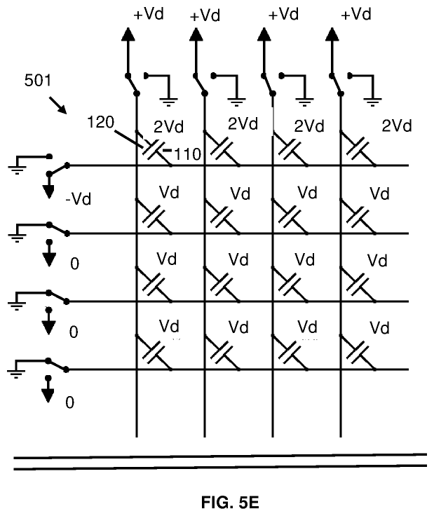

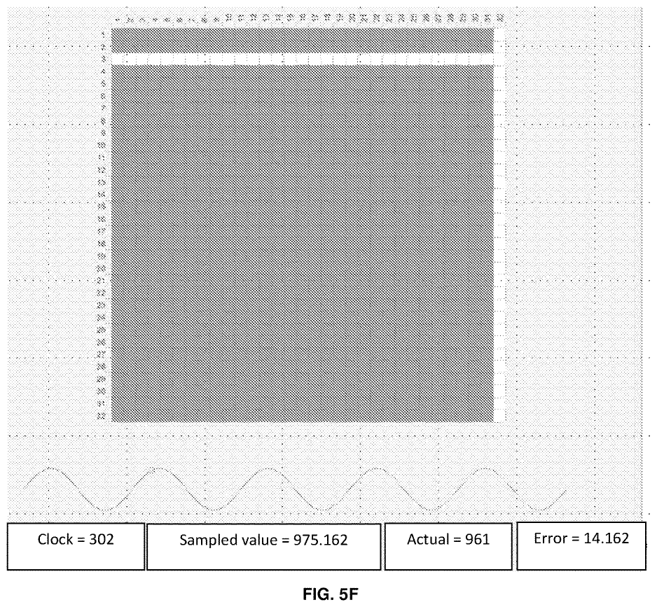

Attention is drawn to FIG. 5A, which describes an embodiment of a method of controlling the electro-mechanical device 300.

The method includes obtaining (operation 500) an input signal informative of a desired physical effect (e.g. sound). The input signal is sampled periodically with a periodicity dictated by a sampling clock. For each given sampling time, a corresponding given sampled value of the input signal is obtained.

Assume that the first array 301 includes a number of first actuator elements equal to N_{C1}*N_{R1}. Assume that the second array 302 includes a number of second actuator elements equal to N_{C2}*N_{R2}.

In some embodiments of the current invention, the number of selected rows and columns to use in each array can be calculated by the controller in “real-time” by evaluating the expression C₁*R₁+C₂*R₂, where C₁ and R₁ are the numbers of respectively selected columns and rows in the first array and C₂ and R₂ are the numbers of respectively selected columns and rows in the second array. Said expression produces the total number of moving elements affected by selecting the specific values for C₁, R₁, C₂, and R₂. Using various optimization techniques (optimization algorithms), it is possible to select values for which said expression produces a number closest to the input signal.

Note that in some array configurations (e.g. in which one of N_{C1}, N_{R1}, N_{C2}, N_{R2} is equal to 1), it is possible to calculate the values C₁, R₁, C₂ and R₂ directly, without requiring optimization. By way of example, assuming N_{R2}=1 and the input signal is equal to S, then:

$${R}_{1} = {N}_{R 1}$$

$${C}_{1} = [ \frac{S}{{N}_{R 1}} ]$$

$${R}_{2} = 1$$

$${C}_{2} = S - {R}_{1} * {C}_{1}$$

Note that since C₁ is an integer, the ratio S/N_{R1} may be rounded down.

It is also possible to pre-calculate the optimal values of C₁, R₁, C₂ and R₂ for every possible value of S and store the values in a database. The database therefore stores, for each given value of a plurality of possible signal values (input signal values), first data informative of a number of moving elements of the first actuator elements to be moved, and second data informative of a number of moving elements of the second actuator elements to be moved, to enable the physical effect (e.g. sound) produced by the electro-mechanical device 300 for this given value.

A non-limitative example of this database 550 is provided in FIG. 5C.

For a value equal to “1” of the input signal, the database 550 stores that one row and one column of the first array have to be selected. Indeed, this enables inducing motion of one moving element.

For a value equal to “2” of the input signal, the database 550 stores that two rows and one column of the first array have to be selected. Indeed, this enables inducing motion of two moving elements.

For a value equal to “11” of the input signal, the database 550 stores that five rows and two columns of the first array have to be selected, and that one row and one column of the second array have to be selected. Indeed, this enables inducing motion of a total of 11 moving elements (10 moving elements from the first array, and one moving element from the second array).

The database stores, for (N_{C1}*N_{R1})+ (N_{C2}*N_{R2}) values of the input signal, the number of rows and columns that need to be selected respectively in the first array and in the second array. This enables to move a number of moving elements which corresponds to the value stored in the database for the input signal.

Note that the input signal is not necessarily located between 0 and (N_{C1}*N_{R1})+(N_{C2}*N_{R2}), but can be rescaled to be located in this range.

Note that the database does not necessarily store which specific rows or columns should be selected for each array. For example, if the database indicates that five columns and two rows should be selected, the database does not necessarily impose which five columns should be selected within the first (or second) array (in some embodiments, and the database also stores which columns and which rows should be selected). The actual choice of the rows and columns can be performed depending on various constraints, such as optimization of electrical consumption, etc.

In other embodiments, the database can store, for each of plurality of values of the input signal, a number of moving elements to be moved for the first array and a number of moving elements to be moved for the second array. Based on these numbers, the controller can decide on the number of rows and columns to select for each array.

The selection of a given row and/or of a given column can include applying a voltage bias between the electrode and the moving element located at this given row/column, which enables a motion of the moving element located at the corresponding row and column. The motion typically includes moving the moving element from its at-rest position to a latched position, or conversely. This can be used both in a configuration in which one-sided actuator elements are used (in this case, the voltage bias is applied between the electrode and the moving element), and in a configuration in which two-sided actuator elements are used (in this case, the voltage bias is applied between the top electrode and the moving element, or between the bottom electrode and the moving element).

A non-limitative example is illustrated in FIG. 5D.

Assume that the first row and the second column of the first array 501 need to be selected (in FIG. 5D, the second array is not depicted, for simplicity). Assume that the controller can apply to the columns, either a voltage +Vd or a zero voltage (0V), and to the rows, either a voltage −Vd or a zero voltage (0V). Selection of a given row (or of a given column) can include applying the voltage to all moving elements (or all electrodes depending on the configuration) of the given row (or of the given column) with the high amplitude (+Vd or −Vd).

Note that each actuator element can be modelled as a capacitor, to which a voltage bias is applied.

In order to select the first row, a voltage-Vd is applied to the first row. In the non-limitative example of FIG. 5D, the moving elements are connected along the rows of the first array (as explained above, this is not limitative). Therefore, all moving elements 110 of the first row of the first array 501 have an electrical potential equal to −Vd.

In order to select the second column, a voltage +Vd is applied to the second column. In the non-limitative example of FIG. 5D, the electrodes are connected along the columns of the first array (as explained above, this is not limitative). Therefore, all electrodes 120 of the first row of the first array 501 have an electrical potential equal to +Vd.

The voltage bias of 2Vd has a sufficient amplitude to move the moving element 110 from its at-rest position to an extreme position (latched position), in close vicinity to the electrode 120. Therefore, only the moving element 110 located at the first row and the second column of the first array is moved towards the electrode 120.

The voltage bias Vd (or −Vd) is not sufficiently high to move a moving element from its at-rest position to its extreme position. However, if a moving electrode is already latched at its extreme position, the voltage bias Vd (or −Vd) has a sufficient amplitude to maintain the moving element at its current latched position.

Note that the principles described in FIG. 5D can be applied similarly to the second array, since each array is electrically insulated from the other.

FIG. 5E describes a variant of FIG. 5D, in which the whole first row is selected. This can be performed by applying a voltage −Vd to the first row (and a zero voltage to all other rows), and a voltage +Vd to all columns of the first array.

As a consequence, all moving elements 110 of the first row are moved from their at-rest position to their extreme position (latched position) in close vicinity to their respective electrodes 120. The other moving elements 110 remain at their previous respective positions (at-rest position or latched position).

The same principles described with respect to FIGS. 5D and 5E can be used for an array in which each actuator element includes two electrodes and a moving element.

In order to move the moving element (located at a given row and column of the array) towards the upper electrode, the electrical connection connecting all moving elements of this given row is selected, and the electrical connection connecting all upper electrodes of this given column is selected.

In order to move the moving element (located at a given row and column of the array) towards the bottom electrode, the electrical connection connecting all moving elements of this given row is selected, and the electrical connection connecting all bottom electrodes of this given column is selected.

Reverting to the method of FIG. 5A, the method includes (operation 510), for the given sampling value of the input signal, searching in the database for a given value which matches the given sampling value according to a matching criterion. Generally, the value which is the closest to the given sampling value is extracted. Note that there can be an addressing error between the actual value of the input signal and the actual number of moving elements which are moved, as explained hereinafter.

As explained with reference to FIG. 5C, this given value is associated in the database with first data informative of a number of moving elements of the first actuator elements to be moved, and second data informative of a number of moving elements of the second actuator elements to be moved. The first data and the second data are extracted (or read) by the controller from the database.

Once the number of rows and columns to be selected in each array is known (using the first data and the second data extracted from the controller), the controller controls (operation 520) the first array and the second array accordingly. The controller may apply the required voltage to the corresponding rows and columns of each array, or can send a command to a voltage source (high voltage driver) to apply the required voltage to the corresponding rows and columns of each array.

Attention is now drawn to FIG. 5B, which illustrates an example of the method of FIG. 5A.

Assume that the electro-mechanical device 300 includes a first array 511 which includes 1 row and 32 columns (in other words, the first array 511 includes 32 first actuator elements).

Assume that the electro-mechanical device 300 includes a second array 512 which includes 31 rows and 32 columns (in other words, the second array 512 includes 992 first actuator elements).

Assume that the input signal has a sampled value of 975.162. The controller searches in the database for the closest value, which is, in this case, 975. For the value “975”, the database stores that, for the first array 511, the single row should be selected, together with 14 columns, and, for the second array 512, 31 rows should be selected, together with 31 columns. This selection enables the motion of 975 moving elements ((14)+(31*31)=975).

There is a minor error between the actual value of the input signal and the number of moving elements which are moved (the error is equal to 0.162).

Note that if an electro-mechanical device with a single array of 32*32 actuator elements is used (which is not split as in the embodiments described above), it is necessary to select 31 rows and 31 columns, which corresponds to 961 moving elements which are moved (see FIG. 5F). The use of two arrays (which can be of different size) reduces the addressing error (error of 0.162 instead of an error of 14.162).

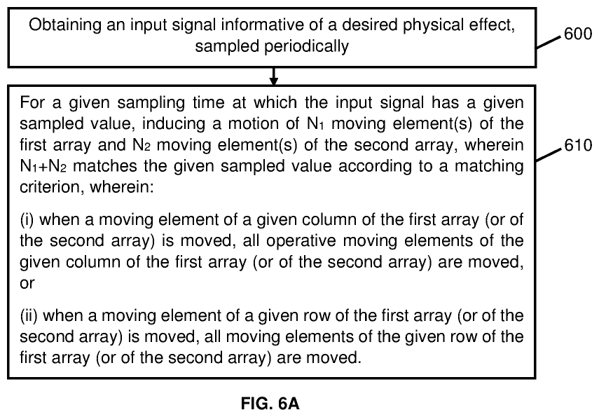

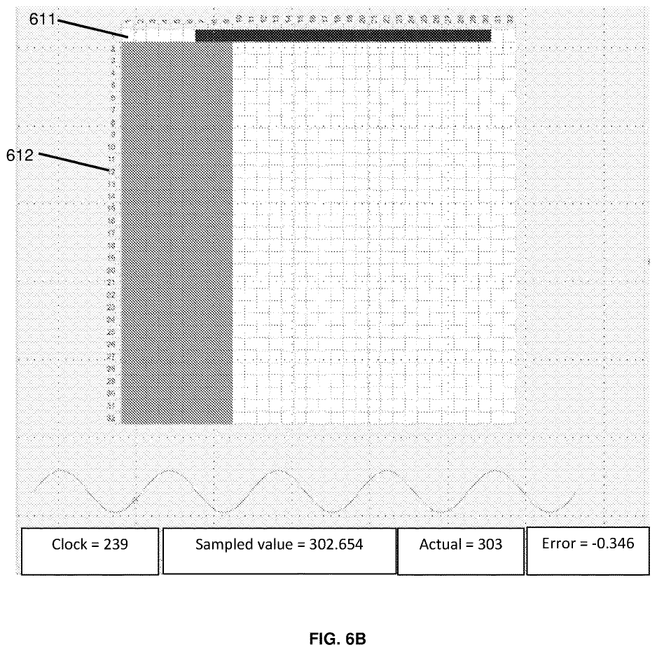

Attention is now drawn to FIG. 6A, which describes another embodiment of controlling the electro-mechanical device.

The method includes obtaining (operation 600) an input signal informative of a desired physical effect (e.g., sound). The input signal is sampled periodically with a periodicity dictated by a sampling clock. For each given sampling time, a corresponding given sampled value of the input signal is obtained.

The method further includes using (operation 610) the controller to induce a motion of N₁ moving elements of the first array and a motion of N₂ moving elements of the second array. In some embodiments, N₁≥1 and N₂≥2.

In this embodiment, when the controller induces a motion of a moving element of a first actuator element of a given column of the first array, it also induces motion of all operative moving elements of all first actuator elements located on the same given column of the first array (note that there can be one or more faulty moving elements, which will not move). In other words, the whole column (full column) of the first array is always selected. For a given column of the first array selected by the controller, the controller therefore always induces a motion of all operative moving elements of this given column of the first array.

Alternatively, (or in addition), when the controller induces a motion of a moving element of a second actuator element of a given column of the second array, it also induces motion of all operative moving elements of all second actuator elements located on the same given column of the second array (note that there can be one or more faulty moving elements, which will not move). In other words, the whole column of the second array is always selected. For a given column of the second array selected by the controller, the controller therefore always induces a motion of all operative moving elements of this given column of the second array.

In this case, N₁ is a multiple of N_{R1} (N₁=k*N_{R1}, with k an integer between 1 and N_{C2}) and/or N₂ is a multiple of N_{R2} (N₂=k′*N_{R2}, with k′ an integer between 1 and N_{C2}). In other words, each time a given column of the first array and/or of the second array is selected, all rows of this given column are selected. The architecture of FIG. 3M can be used, in which all moving elements (connected along the rows) of the first array and/or of the second array always receive the same electrical potential (same voltage). This is however not limitative. In other embodiments, when the controller induces a motion of a moving element of a first actuator element of a given row of the first array, it also induces motion of all operative moving elements of all first actuator elements located on the same given row of the first array. In other words, the whole row of the first array is always selected. For a given row of the first array selected by the controller, the controller therefore always induces a motion of all operative moving elements of this given row of the first array.

Alternatively, (or in addition), when the controller induces a motion of a moving element of a second actuator element of a given row of the second array, it also induces motion of all operative moving elements of all second actuator elements located on the same given row of the second array. In other words, the whole row of the second array is always selected. For a given column of the second array selected by the controller, the controller therefore always induces a motion of all operative moving elements of this given column of the second array.

In this case, N₁ is a multiple of N_{C1} (N₁=k*N_{C1}, with k an integer between 1 and N_{R1}) and/or N₂ is a multiple of N_{C2} (N₂=k′*N_{C2}, with k′ an integer between 1 and N_{R2}). In other words, each time a given row of the first array and/or of the second array is selected, all columns of this given row are selected. The architecture of FIG. 3N can be used, in which all operative moving elements (connected along the columns) of the first array and/or of the second array always receive the same electrical potential (same voltage). Alternatively, the architecture of FIG. 3P can be used. This is however not limitative.

The sum of N₁ and N₂ is selected such that it matches (as much as possible) the sampled value of the input signal.

Note that the determination of N₁ and N₂ can be performed using an algorithm. Assume that the given sampled value of the input signal is equal to Iₖ. Assume that the second array is controlled as explained above, that is to say that for a given column which is selected, all moving elements belonging to this given column are moved.

An integer p is determined, such that the difference A between Iₖ and p*N_{R2} (N₂=m*N_{R2}) is as small as possible. The value p provides the number of columns of the second array in which all moving elements of these columns need to be moved.

Then, the integer N₁ is determined such that the difference between N₁ and Δ is as small as possible. The controller then induces motion of a number N₁ of moving elements of the first array. Note that in some embodiments, the first array can be also controlled as explained above, that is to say that for a given column of the first array which is selected, all moving elements belonging to this given column are moved. In this case, once N₁ has been determined, an integer p″ is determined such that the difference between N₁ and p″*N_{R1} is a small as possible. The value p″ provides the number of columns of the first array in which all moving elements of these columns need to be moved.

Note that other algorithms can be used.

Alternatively, assume that the second array is controlled as explained above, that is to say that for a given row which is selected, all moving elements belonging to this given row are moved.

An integer m is determined, such that the difference A between Iₖ and m*N_{C2} (N₂=m*N_{C2}) is as small as possible. The value m provides the number of rows of the second array in which all moving elements of these rows need to be moved.

Then, the integer N₁ is determined such that the difference between N₁ and Δ is as small as possible. The controller then induces motion of a number N₁ of moving elements of the first array. Note that in some embodiments, the first array can be also controlled as explained above, that is to say that for a given row which is selected, all moving elements belonging to this given row are moved. In this case, once N₁ has been determined, an integer p″ is determined such that the difference between N₁ and p″*N_{C1} is a small as possible. The value p″ provides the number of rows of the first array in which all moving elements of these rows need to be moved.

Note that other algorithms can be used.

In some embodiments (see FIG. 3O), for the first array 301, when the controller induces a motion of a moving element of a first actuator element of a given column of the first array it also induces motion of all operative moving elements of all first actuator elements located on the same given column of the first array (note that there can be one or more faulty moving elements, which will not move). In other words, the whole column (full column) of the first array is always selected.

When the controller induces a motion of a moving element of a second actuator element of a given row of the second array 302, it also induces motion of all operative moving elements of all second actuator elements located on the same given row of the second array (note that there can be one or more faulty moving elements, which will not move). In other words, the whole row of the second array is always selected.

The architecture of FIG. 3O can be used for this.

FIG. 6B illustrates an example of the method of FIG. 6A.

Assume that the electro-mechanical device 300 includes a first array 611 which includes 1 row and 32 columns (in other words, the first array 611 includes 32 first actuator elements).

Assume that the electro-mechanical device 300 includes a second array 612 which includes 31 rows and 32 columns (in other words, the second array 612 includes 992 first actuator elements).

Assume that the moving elements of the second array 612 are connected along the columns of the second array, and that all moving elements are connected to the same electrical potential.

Assume that the input signal has a sampled value of 302.654. The controller determines that 9 full columns of the second array 612 should be selected (since 9*31=279 is the multiple of 31 which is the closest to 302.654).

There remains a difference of Δ=302.654−279=23.654. Therefore, 24 moving elements should be moved in the first array (since the first array has one row, this includes selecting the single row and 24 columns).

The error is −0.346. Note that if a single array of 32*32 actuator elements had been used (in a configuration in which full columns are always selected), this would require selection of 9 columns, and the error would be 302.654−(9*32)=14.654

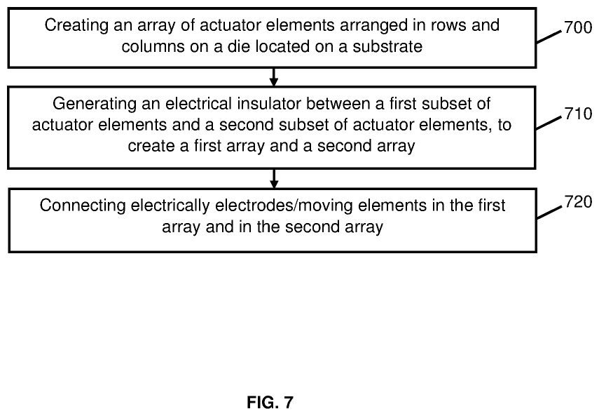

Attention is now drawn to FIG. 7, which describes a method of manufacturing the electro-mechanical device 300 (in case where the first array and the second array are located on the same die).

The method includes creating (operation 700) an array of actuator elements arranged in rows and columns on a die located on a substrate. This can include depositing an electrode layer, and depositing of a layer of moving elements (a moving element layer). Each actuator element is created with a bearing coupled to the moving element (see e.g., WO 2011/111042 of the Applicant)

The method includes (operation 710) generating an electrical insulator between a first subset of actuator elements and a second subset of actuator elements. This enables to generate a first array of first actuator elements and a second array of second actuator elements.

In some embodiments, the electrical insulator insulates all electrodes of the first actuator elements from all electrodes of the second actuator elements. This can include e.g. generating a trench (hole) in the electrode layer, which insulates, electrically, all electrodes of the first actuator elements from all electrodes of the second actuator elements.

In some embodiments, the electrical insulator insulates all moving elements of the first actuator elements from all moving elements of the second actuator elements. This can include generating a trench (hole) in the moving element layer, which insulates, electrically, all moving elements of the first actuator elements from all moving elements of the second actuator elements.

The method further includes connecting (operation 720) electrically the electrodes of the first array which belong to the same row of the first array, connecting electrically the electrodes of the second array which belong to the same row of the second array, connecting electrically the moving elements of the first array which belong to the same column of the first array, and connecting electrically the moving elements of the second array which belong to the same column of the second array. Alternatively, the method includes connecting electrically the electrodes of the first array which belong to the same column of the first array, connecting electrically the electrodes of the second array which belong to the same column of the second array, connecting electrically the moving elements of the first array which belong to the same row of the first array, and connecting electrically the moving elements of the second array which belong to the same row of the second array. The orientation of the electrical insulator (along the row or the columns) and the orientation of the electrical connections in the first array and in the second array can be implemented as explained in one of the various embodiments described above.

It is to be understood that the invention is not limited in its application to the details set forth in the description contained herein or illustrated in the drawings.

The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

It is appreciated that certain functionalities described herein e.g. moving element control functionalities, may if desired be implemented in software.

Features of the present invention which are described in the context of separate embodiments, may also be provided in combination in a single embodiment. Conversely, features of the invention, including method steps, which are described for brevity in the context of a single embodiment or in a certain order, may be provided separately or in any suitable subcombination or in a different order. “e.g.” is used herein in the sense of a specific example which is not intended to be limiting.

It is appreciated that in the description and drawings shown and described herein, functionalities described or illustrated as systems and sub-units thereof can also be provided as methods and steps therewithin, and functionalities described or illustrated as methods and steps therewithin can also be provided as systems and sub-units thereof. The scale used to illustrate various elements in the drawings is merely exemplary and/or appropriate for clarity of presentation and is not intended to be limiting.

In embodiments of the presently disclosed subject matter, fewer, more, and/or different stages than those shown in the methods described in reference to the different drawings may be executed. In embodiments of the presently disclosed subject matter, one or more stages illustrated in the methods described in reference to the different drawings may be executed in a different order, and/or one or more groups of stages may be executed simultaneously.

1. An electro-mechanical device comprising:
a first array comprising a plurality of first actuator elements, and a second array comprising a plurality of second actuator elements,
wherein the first array and the second array are located on a same substrate,
wherein each of the first actuator elements of the first array is not electrically connected to any one of the second actuator elements of the second array,
wherein each of the first actuator elements and of the second actuator elements comprises a moving element, at least one electrode, and a bearing coupled to the moving element, wherein control of an application of a voltage to at least one of the moving element or the electrode enables controlling motion of the moving element,
wherein the first actuator elements are arranged along N_{R1} rows and N_{C1} columns of the first array, wherein N_{R1}≥1 and N_{C1}≥1, wherein at least one of N_{R1} or N_{C1} is equal to or larger than 2,
wherein the first array comprises a plurality of first electrical connections arranged such that (i) or (ii) is met:
(i) for N_{C1}≥2, the moving elements of the first actuator elements belonging to a same row of the first array are electrically connected, and for N_{R1}≥2, the electrodes of the first actuator elements belonging to a same column of the first array are electrically connected, or
(ii) for N_{R1}≥2, the moving elements of the first actuator elements belonging to a same column of the first array are electrically connected, and for N_{C1}≥2, the electrodes of the first actuator elements belonging to a same row of the first array are electrically connected,
wherein the second actuators elements are arranged along N_{R2} rows and N_{C2} columns, wherein at least one of N_{R2} or N_{C2} is equal to or larger than 2,
wherein the second array comprises a plurality of second electrical connections arranged such that (iii) or (iv) is met:
(iii) for N_{C2}≥2, the moving elements of the second actuator elements belonging to a same row of the second array are electrically connected, and for N_{R2}≥2, the electrodes of the second actuator elements belonging to a same column of the second array are electrically connected, or (iv) for N_{R2}≥2, the moving elements of the second actuator elements belonging to a same column of the second array are electrically connected, and for N_{C2}≥2, the electrodes of the second actuator elements belonging to a same row of the second array are electrically connected.

2. The electro-mechanical device of claim 1, wherein at least one of (i), (ii), (iii), (iv), (v) or (vi) is met:
(i) the electro-mechanical device comprises at least one electrical insulator located between the first array and the second array;
(ii) the electro-mechanical device comprises an electrical insulator which electrically insulates all electrodes of the first actuator elements from all electrodes of the second actuator elements;
(iii) the electro-mechanical device comprises an electrical insulator which is located in a layer used to manufacture the electrodes of the first actuator elements and the electrodes of the second actuator elements;
(iv) the electro-mechanical device comprises an electrical insulator which is located in a layer used to manufacture the electrodes of the first actuator elements and the electrodes of the second actuator elements;
(v) the electro-mechanical device comprises an electrical insulator which electrically insulates all moving elements of the first actuator elements from all moving elements of the second actuator elements;
(vi) the electro-mechanical device comprises an electrical insulator which is located in a layer used to manufacture the moving elements of the first actuator elements and the moving elements of the second actuator elements.

3-6. (canceled)

7. The electro-mechanical device of claim 1, wherein (i), (ii), (iii), (iv), (v), (vi), (vii), (viii) or (ix) is met:
(i) N_{R2} is equal to N_{R1};
(ii) N_{C2} is equal to N_{C1};
(iii) a number of the first actuator elements is different from a number of the second actuator elements;
(iv) the N_{R1} rows of the first array are parallel to the N_{R2} rows of the second array;
(v) the number N_{R1} of rows of the first array is different from the number N_{R2} of rows of the second array;
(vi) the N_{C2} columns are parallel to the N_{C1} columns;
(vii) the number N_{C2} of columns of the second array is different from the number N_{C1} of columns of the first array;
(viii) the electrical insulator extends along a direction parallel to the rows of the first array or of the second array;
(ix) the electrical insulator extends along a direction parallel to the columns of the first array or of the second array.

8-11. (canceled)

12. The electro-mechanical device of claim 1, wherein the first array comprises a single row and at least two columns, wherein the second array comprises at least two rows and at least two columns.

13-18. (canceled)

19. The electro-mechanical device of claim 1, wherein (i) or (ii) is met:
(i) the first array and the second array are located on a same die located on said same substrate;
(ii) the first array is located on a first die, and the second array is located on a second die distinct from the first die, wherein the first die and the second die are located on said same substrate.

20. (canceled)

21. The electro-mechanical device claim 1, operative to generate a sound in a range of wavelengths including a minimal wavelength value λmin, wherein any of the first actuator elements of the first array is located at a distance from any of the second actuator elements of the second array which is equal to or smaller than λmin.

22. The electro-mechanical device of claim 1, comprising a third array comprising a plurality of third actuator elements, wherein the first array, the second array and the third array are located on a same substrate, wherein each of the third actuator elements comprises a moving element, at least one electrode, and a bearing coupled to the moving element, wherein control of an application of a voltage to at least one of the moving element or the electrode enables controlling motion of the moving element, wherein each of the third actuator elements of the third array is not electrically connected to any one of the first actuator elements of the first array and to any one of the second actuator elements of the second array.

23. The electro-mechanical device of claim 1, wherein each first actuator element comprises a moving element operative to move along a first axis, and each second actuator element comprises a moving element operative to move along a second axis orthogonal to the first axis.

24. The electro-mechanical device of claim 1, further comprising a controller operative to obtain a digital input signal sampled periodically in accordance with a sampling clock, wherein, for a given sampled value of the digital input signal at a given sampling time, the controller is operative to enable application of a voltage bias between an electrode and a moving element of a first number of first actuator elements of the first array, and to enable application of a voltage bias between an electrode and a moving element of a second number of second actuator elements of the second array, for generating a sound, wherein at least one attribute thereof corresponds to said given sampled value according to a matching criterion.

25. The electro-mechanical device of claim 24, wherein the controller is operatively coupled to a database, storing, for each of a plurality of signal values, first data informative of a number of moving elements of the first actuator elements to be moved, and second data informative of a number of moving elements of the second actuator elements to be moved, wherein the controller is configured to: extract, from the database, given first data informative of a number of moving elements of the first actuator elements to be moved, and given second data informative of a number of moving elements of the second actuator elements to be moved, wherein the given first data and the given second data are associated in the database with a signal value matching the given sampled value according to a matching criterion, and control the first array and the second array using said given first data and given second data.

26. The electro-mechanical device of claim 25, wherein the controller is operative to use an optimization method to determine the first number of first actuator elements of the first array to be moved and the second number of second actuator elements of the second array to be moved.

27. The electro-mechanical device of claim 24, wherein (i) or (ii) is met:
(i) for any column of the first array in which a moving element is moved in response to a command of the controller, a motion of at least all operative moving elements of said column of the first array is also induced, or
for any column of the second array in which a moving element is moved in response to a command of the controller, a motion of at least all operative moving elements of said column of the second array is also induced,
(ii) for any row of the first array in which a moving element is moved in response to a command of the controller, a motion of at least all operative moving elements of said row of the first array is also induced, or
for any row of the second array in which a moving element is moved in response to a command of the controller, a motion of all moving elements of said row of the second array is also induced.

28. The electro-mechanical device of claim 27, wherein (a) or (b) or (c) or (d) is met:
(a) all moving elements of the first array are electrically connected to a same electrical potential, or
(b) all moving elements of the second array are electrically connected to a same electrical potential, or
(c) all electrodes of the first array are electrically connected to a same electrical potential, or
(d) all electrodes of the second array are electrically connected to a same electrical potential.

29. The electro-mechanical device of claim 24, wherein for any column of the first array in which a moving element is moved in response to a command of the controller, a motion of at least all operative moving elements of said column of the first array is also induced, and for any row of the second array in which a moving element is moved in response to a command of the controller, a motion of at least all operative moving elements of said row of the second array is also induced.

30. The electro-mechanical device of claim 29, wherein all moving elements of the first array are electrically connected to a same first electrical potential and all electrodes of the second array are electrically connected to a same second electrical potential.

31. The electro-mechanical device of claim 1, wherein the electro-mechanical device is part of a digital sound reconstruction speaker, or of a detection system.

32. (canceled)

33. A method of controlling an electro-mechanical device comprising a first array comprising a plurality of first actuator elements, and a second array comprising a plurality of second actuator elements, wherein the first array and the second array are located on a same substrate, wherein each of the first actuator elements of the first array is not electrically connected to any one of the second actuator elements of the second array, wherein each of the first actuator elements and of the second actuator elements comprises a moving element, at least one electrode, and a bearing coupled to the moving element, wherein control of an application of a voltage to at least one of the moving element or the electrode enables controlling motion of the moving element, the method comprising, by a controller:
obtaining a digital input signal sampled periodically in accordance with a sampling clock,
for a given sampled value of the digital input signal at a given sampling time, enabling application of a voltage bias between an electrode and a moving element of a first number of first actuator elements of the first array, and enabling application of a voltage bias between an electrode and a moving element of a second number of second actuator elements of the second array, for generating a sound, wherein at least one attribute thereof corresponds to said given sampled value according to a matching criterion.

34. The method of claim 33, wherein the controller is operatively coupled to a database storing, for each a plurality of signal values, first data informative of a number of moving elements of the first actuator elements to be moved, and second data informative of a number of moving elements of the second actuator elements to be moved, wherein the method comprises:
extracting, from the database, given first data informative of a number of moving elements of the first actuator elements to be moved, and given second data informative of a number of moving elements of the second actuator elements to be moved, wherein the given first data and the given second data are associated in the database with a signal value matching the given sampled value according to a matching criterion, and
controlling the first array and the second array using said given first data and given second data.

35. The method of claim 33, wherein (i) or (ii) or (iii) is met:
(i) for any column of the first array in which a moving element is moved in response to a command of the controller, a motion of at least all operative moving elements of said column of the first array is also induced, or for any column of the second array in which a moving element is moved in response to a command of the controller, a motion of at least all operative moving elements of said column of the second array is also induced;
(ii) for any row of the first array in which a moving element is moved in response to a command of the controller, a motion of at least all operative moving elements of said row of the first array is also induced, or for any row of the second array in which a moving element is moved in response to a command of the controller, a motion of at least all operative moving elements of said row of the second array is also induced;
(iii) for any column of the first array in which a moving element is moved in response to a command of the controller, a motion of at least all operative moving elements of said column of the first array is also induced, and for any row of the second array in which a moving element is moved in response to a command of the controller, a motion of at least all operative moving elements of said row of the second array is also induced.

36-38. (canceled)

39. A non-transitory computer readable medium comprising instructions that, when executed by one or more processing circuitries, cause the one or more processing circuitries to perform a method of controlling an electro-mechanical device comprising a first array comprising a plurality of first actuator elements, and a second array comprising a plurality of second actuator elements, wherein the first array and the second array are located on a same substrate, wherein each of the first actuator elements of the first array is not electrically connected to any one of the second actuator elements of the second array, wherein each of the first actuator elements and of the second actuator elements comprises a moving element, at least one electrode, and a bearing coupled to the moving element, wherein control of an application of a voltage to at least one of the moving element or the electrode enables controlling motion of the moving element, the method comprising:
obtaining a digital input signal sampled periodically in accordance with a sampling clock,
for a given sampled value of the digital input signal at a given sampling time, enabling application of a voltage bias between an electrode and a moving element of a first number of first actuator elements of the first array, and enabling application of a voltage bias between an electrode and a moving element of a second number of second actuator elements of the second array, for generating a sound, wherein at least one attribute thereof corresponds to said given sampled value according to a matching criterion.
